(19) United States
(12) Patent Application Publication
(10) Pub. No.: US 2014/0065450 A1
(43) Pub. Date: Mar. 6, 2014

(54) SECONDARY BATTERY, METHOD OF MANUFACTURING THE SAME, BATTERY PACK, AND ELECTRIC VEHICLE

(71) Applicant: Sony Corporation, Tokyo (JP)

(72) Inventors: Masaharu Senoue, Fukushima (JP); Masayuki Iwama, Fukushima (JP); Kenichi Kawase, Fukushima (JP)

(73) Assignee: Sony Corporation, Tokyo (JP)

(21) Appl. No.: 14/016,895

(22) Filed: Sep. 3, 2013

(30) Foreign Application Priority Data
Sep. 6, 2012 (JP) 2012-196109

(51) Int. Cl. H01M 4/36; H01M 4/78

(52) U.S. Cl. CPC H01M 4/366; H01M 4/78
USPC 429/7; 429/211; 429/94

(57) ABSTRACT

A secondary battery includes: a cathode; an anode; and an electrolytic solution, wherein the anode includes an anode active material layer, the anode active material layer being provided on part of an anode current collector, and a breaking elongation δ2 (percent) of the anode current collector in a second region is larger than a breaking elongation δ1 (percent) of the anode current collector in a first region, the second region not being provided with the anode active material layer, and the first region being provided with the anode active material layer.

### CROSS REFERENCES TO RELATED APPLICATIONS

The present application claims priority to Japanese Priority Patent Application JP 2012-196109 filed in the Japan Patent Office on Sep. 6, 2012, the entire content of which is hereby incorporated by reference.

### BACKGROUND

The present application relates to a secondary battery including an anode in which an anode active material layer is provided in part of an anode current collector, to a method of manufacturing the same, and to a battery pack and an electric vehicle that use the secondary battery.

In recent years, various electronic apparatuses such as a mobile phone and a personal digital assistant (PDA) have been widely used, and it has been demanded to further reduce the size and the weight of the electronic apparatuses and to achieve their long life. Accordingly, as an electric power source for the electronic apparatuses, a battery, in particular, a small and light-weight secondary battery capable of providing high energy density has been developed.

In these days, it has been considered to apply the secondary battery to various applications in addition to the foregoing electronic apparatuses. Representative examples of such various applications may include a battery pack attachably and detachably mounted on the electronic apparatuses or the like, an electric vehicle such as an electric automobile, an electric power storage system such as a home electric power server, and an electric power tool such as an electric drill.

Secondary batteries utilizing various charge and discharge principles to obtain a battery capacity have been proposed. In particular, a secondary battery utilizing insertion and extraction of an electrode reactant, a secondary battery utilizing precipitation and dissolution of an electrode reactant, and the like have attracted attention, since these secondary batteries provide higher energy density than lead batteries, nickel-cadmium batteries, and the like.

The secondary battery includes a cathode, an anode, and an electrolytic solution. The anode includes an anode active material layer provided on an anode current collector. The anode active material layer contains an active material (an anode active material) capable of inserting and extracting an electrode reactant, and an anode binder and/or the like as necessary. The anode active material layer may be provided on the entire anode current collector, or may be provided on part thereof.

Various studies have been made on specific configurations of the anode. For example, in order to suppress occurrence of wrinkles and/or the like in an anode current collector at the time of charge and discharge, the tension strength (N/mm²) of the anode current collector is specified (for example, see Japanese Unexamined Patent Application Publication Nos. 2003-007305 and 2005-285651). Further, in order to suppress buckling of a group of electrodes associated with expansion and shrinkage of an anode active material, the tensile elongation rate (%) of a cathode plate is larger than the tensile elongation rate (%) of an anode plate (for example, see Japanese Unexamined Patent Application Publication No. 2009-266761).

In addition thereto, in order to suppress lowering of current collectivity associated with progression of charge and discharge cycles, in the case where polyimide is used as an anode binder, an anode is subjected to heat treatment at temperature higher than glass transition temperature of the polyimide (for example, see Japanese Unexamined Patent Application Publication Nos. 2009-238659 and 2009-245773).

### SUMMARY

In the case where an anode active material layer is expanded and shrunk at the time of charge and discharge, an anode current collector may be deformed, or in some cases, may be broken, being influenced by stress generated at the time of such expansion and shrinkage. In particular, if the anode active material layer is provided in part of the anode current collector, such a tendency is significant in the anode current collector in a region not provided with the anode active material layer.

It is desirable to provide a secondary battery, a method of manufacturing the same, a battery pack, and an electric vehicle that are capable of suppressing breakage of an anode.

According to an embodiment of the present application, there is provided a secondary battery including: a cathode; an anode; and an electrolytic solution, wherein the anode includes an anode active material layer, the anode active material layer being provided on part of an anode current collector, and a breaking elongation δ2 (percent) of the anode current collector in a second region is larger than a breaking elongation δ1 (percent) of the anode current collector in a first region, the second region not being provided with the anode active material layer, and the first region being provided with the anode active material layer.

According to an embodiment of the present application, there is provided a battery pack including: a secondary battery; a control section controlling a used state of the secondary battery; and a switch section switching the used state of the secondary battery according to an instruction of the control section, wherein a secondary battery includes a cathode, an anode, and an electrolytic solution, the anode includes an anode active material layer, the anode active material layer being provided on part of an anode current collector, and a breaking elongation δ2 (percent) of the anode current collector in a second region is larger than a breaking elongation δ1 (percent) of the anode current collector in a first region, the second region not being provided with the anode active material layer, and the first region being provided with the anode active material layer.

According to an embodiment of the present application, there is provided an electric vehicle including: a secondary battery; a conversion section converting electric power supplied from the secondary battery into drive power; a drive section operating according to the drive power; and a control section controlling a used state of the secondary battery, wherein a secondary battery includes a cathode, an anode, and an electrolytic solution, the anode includes an anode active material layer, the anode active material layer being provided on part of an anode current collector, and a breaking elongation δ2 (percent) of the anode current collector in a second region is larger than a breaking elongation δ1 (percent) of the anode current collector in a first region, the second region not being provided with the anode active material layer, and the first region being provided with the anode active material layer.

According to an embodiment of the present application, there is provided a method of manufacturing a secondary battery including: forming an anode active material layer on part of an anode current collector; and forming an anode by heating the anode current collector in at least a second region out of the second region in which the anode active material layer is not formed and a first region in which the anode active material layer is formed.

However, a measurement method, measurement conditions, and the like of the breaking elongations δ1 and δ2 are based on the metal material tensile test method prescribed in JIS Z2241.

According to the secondary battery of the embodiment of the present application, since the breaking elongation δ2 is larger than the breaking elongation δ1 in the anode current collector, breakage of the anode is allowed to be suppressed. Further, according to the method of manufacturing the secondary battery of the embodiment of the present application, since after the anode active material layer is formed on part of an anode current collector, the anode current collector in at least the second region is heated, breakage of the anode is allowed to be suppressed. Further, according to the battery pack and the electric vehicle that use the secondary battery of the embodiment of the present application, similar effects are obtainable.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional view schematically illustrating a configuration of an electrode according to an embodiment of the present application.

FIG. 2 is a view illustrating a configuration of a manufacturing equipment of an electrode.

FIG. 3 is a cross-sectional view illustrating a configuration of a secondary battery (cylindrical type) using the electrode according to the embodiment of the present application.

FIG. 4 is a cross-sectional view taken along a line IV-IV of a spirally wound electrode body illustrated in FIG. 3.

FIG. 5 is a cross-sectional view illustrating an enlarged part of the spirally wound electrode body illustrated in FIG. 3.

FIG. 6 is a cross-sectional view schematically illustrating configurations of a cathode and an anode illustrated in FIG. 4.

FIG. 7 is a perspective view illustrating a configuration of another secondary battery (laminated film type) using the electrode according to the embodiment of the present application.

FIG. 8 is a cross-sectional view taken along a line VIII-VIII of a spirally wound electrode body illustrated in FIG. 7.

FIG. 9 is a block diagram illustrating a configuration of an application example (battery pack) of the secondary battery.

FIG. 10 is a block diagram illustrating a configuration of an application example (electric vehicle) of the secondary battery.

FIG. 11 is a block diagram illustrating a configuration of an application example (electric power storage system) of the secondary battery.

FIG. 12 is a block diagram illustrating a configuration of an application example (electric power tool) of the secondary battery.

### DETAILED DESCRIPTION

An embodiment of the present application will be described below in detail with reference to the drawings. The description will be given in the following order.

### 1. Electrode

1-1. Configuration

1-2. Manufacturing Method

### 2. Secondary Battery and Method of Manufacturing the Same

2-1. Lithium Ion Secondary Battery (Cylindrical Type)

2-2. Lithium Ion Secondary Battery (Laminated Film Type)

2-3. Lithium Metal Secondary Battery (Cylindrical Type and Laminated Film Type)

### 3. Applications of Secondary Battery

3-1. Battery Pack

3-2. Electric Vehicle

3-3. Electric Power Storage System

3-4. Electric Power Tool

[1. Electrode]

[1-1. Configuration]

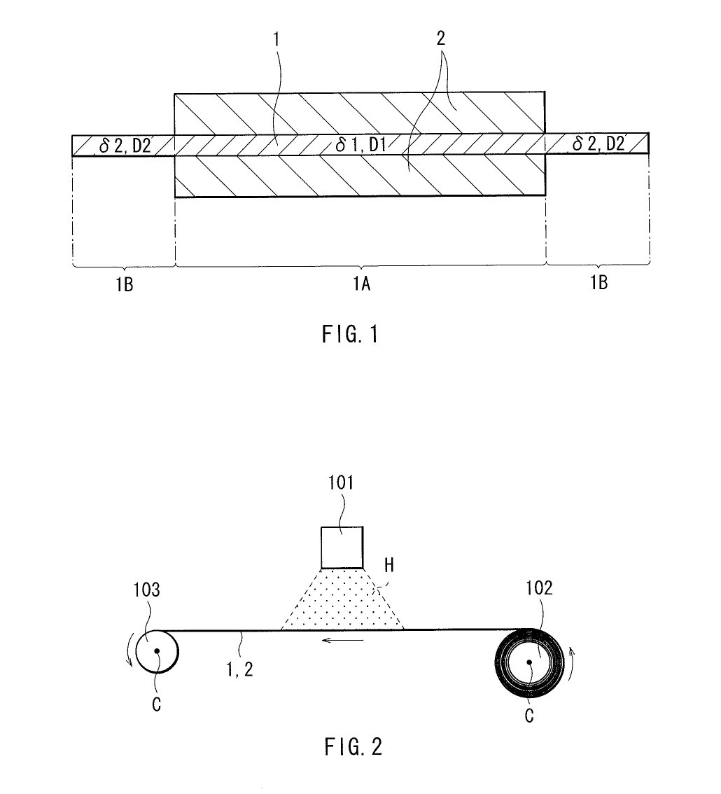

FIG. 1 schematically illustrates a cross-sectional configuration of an electrode according to an embodiment of the present application. The term “schematically” refers to a fact that dimensions, shapes, and the like of respective components may be arbitrary set since the configuration of the electrode is simply illustrated in FIG. 1.

[Whole Configuration of Electrode]

The electrode described below is widely used for electrochemical devices for various purposes. Examples of the electrochemical devices may include a secondary battery and a capacitor. However, the electrode may be used as a cathode, and may be used as an anode.

The electrode includes a current collector 1 and an active material layer 2 provided on the current collector 1. The active material layer 2 may be provided on both surfaces of the current collector 1, and may be provided on a single surface thereof.

However, the active material layer 2 is provided on part of the current collector 1. Accordingly, the anode current collector 1 includes a section (an active material layer existent section 1A) existing in a region (a first region) provided with the active material layer 2 and a section (an active material layer non-existent section 1B) existing in a region (a second region) not provided with the active material layer 2.

In this case, for example, the current collector 1 may have an elongate shape (strip shape) extending in a predetermined direction (a lateral direction in FIG. 1: longitudinal direction). The active material layer 2 is provided in the central region of the current collector 1 in the longitudinal direction. Accordingly, the current collector 1 includes two active material layer non-existent sections 1B located in one end and the other end and one active material layer existent section 1A sandwiched between the two active material layer non-existent sections 1B.

It is to be noted that the electrode may be curved in the longitudinal direction, or may be spirally wound in whorl in the longitudinal direction.

[Current Collector]

The current collector 1 may be, for example, formed of one or more of conductive materials having superior electrochemical stability, superior electric conductivity, and superior mechanical strength. Examples of the conductive materials may include metal materials such as copper (Cu), nickel (Ni), and stainless steel. In particular, a material that does not form an intermetallic compound with an electrode reactant and that is alloyed with the active material layer 2 may be preferable. More specifically, in order to obtain superior electric conductivity, the current collector 1 may preferably contain Cu as a constituent element.

It is to be noted that the term “electrode reactant” refers to a substance working as a medium for an electrode reaction. Examples of the electrode reactant may include lithium (lithium ions) of a lithium ion secondary battery. Further, the term “electrode reaction” refers to an electrochemical reaction occurring with the use of electrodes. Examples of the electrode reaction may include a charge and discharge reaction of a secondary battery.

The surface (the surface in contact with the active material layer 2) of the current collector 1 may be roughened, and is not necessarily roughened. Examples of the current collector 1 not roughened may include a rolled metal foil. Examples of the current collector 1 roughened may include a metal foil subjected to electrolytic treatment, sandblasting treatment, and/or the like. The electrolytic treatment refers to a method of forming fine particles on the surface of a metal foil or the like with the use of an electrolytic method in an electrolytic bath. The metal foil formed by an electrolytic method is generally called an electrolytic foil (such as an electrolytic copper foil).

In particular, the surface of the current collector 1 may be preferably roughened. One reason for this is that adhesibility of the active material layer 2 with respect to the current collector 1 is improved by anchor effect. The surface roughness (such as ten point height of irregularities Rz) of the current collector 1 is not particularly limited. However, in order to improve the adhesibility of the active material layer 2 with respect to the current collector 1 by the anchor effect, the surface roughness of the current collector 1 may be preferably large as much as possible. However, if the surface roughness of the current collector 1 is excessively large, the adhesibility of the active material layer 2 may be lowered.

[Active Material Layer]

The active material layer 2 contains one or more of materials (active materials) capable of inserting and extracting an electrode reactant as active materials, and may also contain other materials such as a binder and an electric conductor as necessary.

Examples of the active material may include one or more of carbon materials. In the carbon material, its crystal structure change at the time of insertion and extraction of an electrode reactant is extremely small. Therefore, the carbon material provides high energy density and the like. Further, the carbon material functions as an electric conductor as well. Examples of the carbon material may include graphitizable carbon, non-graphitizable carbon in which the spacing of (002) plane is equal to or greater than 0.37 nm, and graphite in which the spacing of (002) plane is equal to or smaller than 0.34 nm. More specifically, examples of the carbon material may include pyrolytic carbons, cokes, glassy carbon fiber, an organic polymer compound fired body, activated carbon, and carbon blacks. Examples of the cokes may include pitch coke, needle coke, and petroleum coke. The organic polymer compound fired body is obtained by firing (carbonizing) a polymer compound such as a phenol resin and a furan resin at appropriate temperature. In addition thereto, the carbon material may be low crystalline carbon or amorphous carbon heat-treated at temperature of about 1000 deg C. or less. It is to be noted that the shape of the carbon material may be any of a fibrous shape, a spherical shape, a granular shape, and a scale-like shape.

Further, the active material may be, for example, a material (metal-based material) containing one or more of metal elements and metalloid elements as constituent elements, since higher energy density is thereby obtained. Such a metal-based material may be a simple substance, an alloy, or a compound, may be two or more thereof, or may be a material having one or more phases thereof in part or all thereof. The term “alloy” includes a material containing one or more metal elements and one or more metalloid elements, in addition to a material configured of two or more metal elements. Further, the “alloy” may contain a nonmetallic element. Examples of the structure thereof may include a solid solution, a eutectic crystal (eutectic mixture), an intermetallic compound, and a structure in which two or more thereof coexist.

Examples of the foregoing metal elements and the foregoing metalloid elements may include one or more of metal elements and metalloid elements capable of forming an alloy with an electrode reactant. Specific examples thereof may include Mg, B, Al, Ga, In, Si, Ge, Sn, Pb, Bi, Cd, Ag, Zn, Hf, Zr, Y, Pd, and Pt. In particular, one or more of Si, Sn, and Ge may be preferable. Si, Sn, and Ge have a superior ability of inserting and extracting a reactant, and therefore, provide significantly high energy density.

A material containing one or more of Si, Sn, and Ge as constituent elements (referred to as “Si-based material” below) may be a simple substance, an alloy, or a compound of Si, Sn, or Ge, may be two or more thereof, or may be a material having one or more phases of Si, Sn, and Ge in part or all thereof. However, the term “simple substance” merely refers to a general simple substance (a small amount of impurity may be therein contained), and does not necessarily refer to a purity 100% simple substance.

The alloys of Si may contain, for example, one or more of elements such as Sn, Ni, Cu, Fe, Co, Mn, Zn, In, Ag, Ti, Ge, Bi, Sb, and Cr as constituent elements other than Si. The compounds of Si may contain, for example, one or more of C, O, and the like as constituent elements other than Si. It is to be noted that, for example, the compounds of Si may contain one or more of the elements described for the alloys of Si as constituent elements other than Si.

Specific examples of the alloys of Si and the compounds of Si may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO. It is to be noted that v in SiOᵥ may be in the range of 0.2<v<1.4.

The alloys of Sn may contain, for example, one or more of elements such as Si, Ni, Cu, Fe, Co, Mn, Zn, In, Ag, Ti, Ge, Bi, Sb, and Cr as constituent elements other than Sn. The compounds of Sn may contain, for example, one or more of elements such as C and O as constituent elements other than Sn. It is to be noted that the compounds of Sn may contain, for example, one or more of elements described for the alloys of Sn as constituent elements other than Sn. Specific examples of the alloys of Sn and the compounds of Sn may include SnO_{w} (0<w≦2), SnSiO₃, LiSnO, and Mg₂Sn.

Specific examples of the alloys of Ge and the compounds of Ge may include a material obtained by substituting Ge for Si and Sn out of the specific examples of the alloys and the compounds of Si and Sn.

In particular, of the Si-based materials, as a material containing Sn as a constituent element, for example, a material containing a second constituent element and a third constituent element in addition to Sn as a first constituent element may be preferable. Examples of the second constituent element may include one or more of elements such as Co, Fe, Mg, Ti, V, Cr, Mn, Ni, Cu, Zn, Ga, Zr, Nb, Mo, Ag, In, Ce, Hf, Ta, W, Bi, and Si. Examples of the third constituent element may include one or more of B, C, Al, P, and the like. In the case where the second constituent element and the third constituent element are contained, high energy density and the like are obtained.

In particular, a material containing Sn, Co, and C as constituent elements (SnCoC-containing material) may be preferable. In the SnCoC-containing material, for example, the C content may be from 9.9 mass % to 29.7 mass % both inclusive, and the ratio of Sn and Co contents (Co/(Sn+Co)) may be from 20 mass % to 70 mass % both inclusive, since high energy density is obtained thereby.

It is preferable that the SnCoC-containing material have a phase containing Sn, Co, and C. Such a phase may be preferably low-crystalline or amorphous. The phase is a phase capable of reacting with an electrode reactant (a reaction phase). Therefore, due to existence of the reaction phase, superior characteristics are obtained. The half bandwidth of the diffraction peak obtained by X-ray diffraction of the phase may be preferably equal to or greater than 1 deg based on diffraction angle of 2θ in the case where CuKα ray is used as a specific X ray, and the insertion rate is 1 deg/min. Thereby, the electrode reactant is more smoothly inserted and extracted, and reactivity with the electrolytic solution is decreased. It is to be noted that, in some cases, the SnCoC-containing material includes a phase containing a simple substance or part of the respective constituent elements in addition to the low-crystalline phase or the amorphous phase.

Whether or not the diffraction peak obtained by the X-ray diffraction corresponds to the reaction phase capable of reacting with the electrode reactant is allowed to be easily determined by comparison between X-ray diffraction charts before and after electrochemical reaction with the electrode reactant. For example, if the position of the diffraction peak after electrochemical reaction with the electrode reactant is changed from the position of the diffraction peak before the electrochemical reaction with the electrode reactant, the obtained diffraction peak corresponds to the reaction phase capable of reacting with the electrode reactant. In this case, for example, the diffraction peak of the low crystalline reaction phase or the amorphous reaction phase is seen in the range of 2θ=from 20 deg to 50 deg both inclusive. Such a reaction phase may have, for example, the foregoing respective constituent elements, and the low crystalline or amorphous structure thereof possibly results from existence of C mainly.

In the SnCoC-containing material, part or all of C as a constituent element may be preferably bonded to a metal element or a metalloid element as other constituent element, since cohesion or crystallization of Sn and/or the like is suppressed thereby. The bonding state of elements may be checked with the use of, for example, X-ray photoelectron spectroscopy (XPS). In a commercially available device, for example, as a soft X ray, Al—Kα ray, Mg—Kα ray, or the like may be used. In the case where part or all of C are bonded to a metal element, a metalloid element, or the like, the peak of a synthetic wave of is orbit of C (C1s) is shown in a region lower than 284.5 eV. It is to be noted that in the device, energy calibration is made so that the peak of 4f orbit of Au atom (Au4f) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of carbon in the SnCoC-containing material. Therefore, for example, analysis may be made by using commercially available software to isolate both peaks from each other. In the waveform analysis, the position of the main peak existing on the lowest bound energy side is the energy standard (284.8 eV).

It is to be noted that the SnCoC-containing material is not limited to the material (SnCoC) configured of only Sn, Co, and C as constituent elements. The SnCoC-containing material may further contain, for example, one or more of Si, Fe, Ni, Cr, In, Nb, Ge, Ti, Mo, Al, P, Ga, Bi, and the like as constituent elements in addition to Sn, Co, and C.

In addition to the SnCoC-containing material, a material containing Sn, Co, Fe, and C as constituent elements (SnCoFeC-containing material) may be also preferable. The composition of the SnCoFeC-containing material may be arbitrarily set. For example, the composition in which the Fe content may be set small is as follows. That is, the C content may be from 9.9 mass % to 29.7 mass % both inclusive, the Fe content may be from 0.3 mass % to 5.9 mass % both inclusive, and the ratio of contents of Sn and Co (Co/(Sn+Co)) may be from 30 mass % to 70 mass % both inclusive. In contrast, the composition in which the Fe content is set large is as follows. That is, the C content may be from 11.9 mass % to 29.7 mass % both inclusive, the ratio of contents of Sn, Co, and Fe ((Co+Fe)/(Sn+Co+Fe)) may be from 26.4 mass % to 48.5 mass % both inclusive, and the ratio of contents of Co and Fe (Co/(Co+Fe)) may be from 9.9 mass % to 79.5 mass % both inclusive. In such a composition range, high energy density is obtained. The physical properties (such as half bandwidth) of the SnCoFeC-containing material are similar to those of the foregoing SnCoC-containing material.

In addition thereto, the active material may be, for example, a metal oxide, a polymer compound, or the like. Examples of the metal oxide may include iron oxide, ruthenium oxide, and molybdenum oxide. Examples of the polymer compound may include polyacetylene, polyaniline, and polypyrrole.

The active material layer 2 may be formed by, for example, a coating method, a vapor-phase deposition method, a liquid-phase deposition method, a spraying method, a firing method (sintering method), or a combination of two or more of these methods. The coating method is a method in which, for example, after a particulate (powder) anode active material is mixed with a binder and/or the like, the resultant mixture is dispersed in a solvent such as an organic solvent, and the current collector 1 is coated with the solution, and the resultant is dried. Examples of the vapor-phase deposition method may include a physical deposition method and a chemical deposition method. More specifically, examples thereof may include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase deposition method may include an electrolytic plating method and an electroless plating method. The spraying method is a method in which an active material in a fused state or a semi-fused state is sprayed to the current collector 1. The firing method is, for example, a method in which after the current collector 1 is coated with the use of a coating method, the coated film is subjected to heat treatment at temperature higher than the melting point of the binder and/or the like. Examples of the firing method may include an atmosphere firing method, a reactive firing method, and a hot press firing method.

Examples of the binder may include one or more of synthetic rubbers, polymer materials, and the like. Examples of the synthetic rubber may include a styrene-butadiene-based rubber, a fluorine-based rubber, and ethylene propylene diene. Examples of the polymer material may include polyvinylidene fluoride and polyimide.

Examples of the electric conductor may include one or more of carbon materials and the like. Examples of the carbon materials may include graphite, carbon black, acetylene black, and Ketjen black. The electric conductor may be a metal material, a conductive polymer, or the like as long as the material has electric conductivity.

[Physicality of Electrode]

In the electrode, physicality of the current collector 1 varies according to respective locations.

Specifically, focusing attention on the tension strength of the current collector 1, the active material layer existent section 1A has a breaking elongation δ1(%), and the active material layer non-existent section 1B has a breaking elongation δ2(%). However, the breaking elongation δ2(%) of the active material layer non-existent section 1B is larger than the breaking elongation δ1(%) of the active material layer existent section 1A. A measurement method, measurement conditions, and the like of the “breaking elongation (%)” are based on the metal material tensile test method prescribed in JIS Z2241 as described above.

One of the reasons why the breaking elongation δ2 is larger than the breaking elongation δ1 is that, in this case, an electrode is less likely to be broken at the time of an electrode reaction for the following reason.

In the case where the active material layer 2 is expanded and shrunk at the time of an electrode reaction, the current collector 1 is similarly expanded and shrunk, being influenced by stress generated at the time of the expansion and shrinkage. In this case, in the case where the active material layer 2 is provided in part of the current collector 1, the active material layer non-existent section 1B tends to be more influenced by stress than the active material layer existent section 1A. One reason for this is that while the active material layer existent section 1A is supported by the active material layer 2, the active material layer non-existent section 1B is not supported by the active material layer 2. Thereby, the electrode is easily broken depending on the stress degree. More specifically, a crack easily occurs in the active material layer non-existent section 1B, or the active material layer non-existent section 1B is easily fractured.

In particular, in an electrode in which the current collector 1 includes the active material layer non-existent section 1B, breakage easily occurs in a section having a so-called step. One reason for this is that, since a stress value is drastically changed at the section having a step as a boundary line, stress easily and locally concentrates on such a section of the current collector 1. The section having a step may be located in, for example, a position corresponding to an end of the active material layer 2 (a boundary line between the active material layer existent section 1A and the active material layer non-existent section 1B) of the current collector 1. Further, in the case where a cathode lead, a protective tape and/or the like (not illustrated) is provided in the current collector 1, the section having a step is located in a position corresponding to an end of the electrode lead and/or the like.

In contrast, in the case where the breaking elongation δ2 is larger than the breaking elongation δ1, the active material layer non-existent section 1B is easily deformed (expanded and shrunk) than the active material layer existent section 1A in the current collector 1. Therefore, the active material layer non-existent section 1B easily follows stress. Thereby, a crack and/or the like is less likely to occur in the active material layer non-existent section 1B compared to a case that the breaking elongation δ1 is equal to the breaking elongation δ2 and a case that the breaking elongation δ2 is smaller than the breaking elongation δ1. Accordingly, the electrode is less likely to be broken.

Respective values of the breaking elongations δ1 and δ2 are not particularly limited as long as the breaking elongation δ2 is larger than the breaking elongation δ1. In particular, the breaking elongation δ2 is larger than the breaking elongation δ1 by about 1% or more, and may be preferably larger than the breaking elongation δ1 by about 5% or more. One reason for this is that, in this case, since a sufficient difference exists between the breaking elongations δ1 and δ2, the active material layer non-existent section 1B is easily deformed than the active material layer existent section 1A.

Focusing attention on crystal characteristics of the current collector 1, a crystallite of the active material layer existent section 1A has a crystal particle diameter D1 (μm), and a crystallite of the active material layer non-existent section 1B has a crystal particle diameter D2 (μm). In this case, since the breaking elongation δ2 is larger than the breaking elongation δ1, the crystal particle diameter D2 of the active material layer non-existent section 1B is larger than the crystal particle diameter D1 of the active material layer existent section 1A. The active material layer non-existent section 1B having a relatively large crystal particle diameter is easily deformed than the active material layer existent section 1A having a relatively small crystal particle diameter.

The term “crystal particle diameter” refers to a so-called crystallite size, which is an average value (average crystal particle diameter) of particle diameters of 100 pieces of crystallites. When the crystal particle diameter is obtained, first, a cross section of the current collector 1 is exposed with the use of a cross-section polisher (CP) method. Subsequently, the cross section of the current collector 1 is observed with the use of a scanning electron microscope (SEM) to obtain a reflection electron image. Finally, after particle diameters (dimensions of longitudinal diameters) of arbitrary 100 pieces of crystallites are measured based on the reflection electron image, the average value thereof is calculated.

Respective values of the crystal particle diameters D1 and D2 are not particularly limited as long as the crystal particle diameter D2 is larger than the crystal particle diameter D1. In particular, a value of the crystal particle diameter D2 is preferably larger than the crystal particle diameters D1 by about 30% or more. One reason for this is that, in this case, since a sufficient difference exists between the crystal particle diameters D1 and D2, the active material layer non-existent section 1B is easily deformed than the active material layer existent section 1A.

As described above, in the electrode in which physicality of the active material layer existent section 1A is different from physicality of the active material layer non-existent section 1B, there is an advantage that the electrode is less likely to be broken. In particular, such an electrode is effective in the case where the active material of the active material layer 2 is an Si-based material. One reason for this is that while the Si-based material achieves high energy density, the Si-based material is easily expanded and shrunk significantly at the time of electrode reaction. Even if the Si-based material is used as an active material, by differentiating the physicality of the active material layer existent section 1A and the physicality of the active material layer non-existent section 1B, as described above, high energy density is obtained while breakage of the electrode is suppressed.

[1-2. Manufacturing Method]

The electrode is manufactured by, for example, the following procedure. The description has been already given in detail of the respective formation materials and the like of the current collector 1 and the active material layer 2, and therefore, the descriptions thereof will be omitted.

A description will be given of, for example, a case that a plurality of electrodes are continuously formed with the use of a manufacturing equipment of an electrode illustrated in FIG. 2. FIG. 2 illustrates a configuration of the manufacturing equipment of the electrode. The manufacturing equipment is allowed to continuously perform heat treatment by a so-called roll-to-roll method. For example, the manufacturing equipment may include a heat source 101 such as a heater, a wind-off roller 102 and a wind-up roller 103 that are rotatable centering on a rotation axis C.

In the case where the electrode is manufactured, first, the strip-shaped current collector 1 is prepared. In the current collector 1 in a state before the active material layer 2 is formed, the breaking elongations δ1 and δ2 may be equal to each other. One reason for this is that, by heat treatment in a subsequent step, the breaking elongations δ1 and δ2 may be differentiated thereafter. It is to be noted that the term “the breaking elongations δ1 and δ2 may be equal to each other” does not refer to a fact that respective values of the breaking elongations δ1 and δ2 correspond with each other accurately, and refers to a fact that the current collector 1 is not provided with treatment (heat treatment in this case) to differentiate the foregoing breaking elongations δ1 and δ2.

Subsequently, in the case where a coating method is used as a method of forming the active material layer 2, an active material is mixed with a binder and/or the like as necessary to prepare a mixture. Thereafter, the mixture is dispersed in an organic solvent or the like to obtain paste mixture slurry. Subsequently, each of the respective particular sections (sections to become the active material layer existent sections 1A) of the current collector 1 is coated with the mixture slurry, which is dried to form the plurality of active material layers 2. Thereby, the current collector 1 includes the active material layer existent section 1A and the active material layer non-existent section 1B. Subsequently, the active material layers 2 are compression-molded with the use of a roll pressing machine and/or the like as necessary. In this case, compression-molding may be performed while heating the active material layers 2, or compression-molding may be repeated several times.

Subsequently, out of the current collector 1 in which the plurality of active material layers 2 are formed (referred to as “the current collector 1 and the like” below), at least the active material layer non-existent section 1B is subjected to heat treatment. In this case, for example, after a spirally wound body of the current collector 1 and the like is loaded on the wind-off roller 102, and thereafter, the wind-up roller 103 is rotated together with the wind-off roller 102. Thereby, the current collector 1 and the like sent from the wind-off roller 102 are wound up by the wind-up roller 103. While the current collector 1 and the like are transferred as described above, heat H is continuously radiated from the heat source 101 to the current collector 1 and the like.

As long as the breaking elongations δ1 and δ2 are allowed to be differentiated as described later, heating temperature is not particularly limited, and may be, for example, equal to or more than 300 deg C. Further, the transfer velocity of the current collector 1 and the like may be arbitrarily set according to conditions such as heating temperature, and is not particularly limited as long as the breaking elongations δ1 and δ2 are allowed to be differentiated.

By the foregoing heat treatment, the active material layer existent section 1A and the active material layer non-existent section 1B are heated together. However, the active material layer non-existent section 1B is heated more substantially than the active material layer existent section 1A. Therefore, the breaking elongation δ2 becomes larger than the breaking elongation δ1. More specifically, the specific heat capacity of the active material layer existent section 1A covered with the active material layer 2 is different from the specific heat capacity of the active material layer non-existent section 1B that is not covered with the active material layer 2 and is exposed. While the exposed active material layer non-existent section 1B is directly exposed to the heat H, the active material layer existent section 1A not exposed is indirectly exposed to the heat H. Therefore, the heating amount supplied to the active material layer non-existent section 1B is relatively higher than the heating amount supplied to the active material layer existent section 1A. Therefore, although both the breaking elongations δ1 and δ2 are allowed to be increased by the heat treatment, the breaking elongation δ2 becomes relatively larger than the breaking elongation δ1 finally.

Thereby, the current collector 1 includes the active material layer existent section 1A having the relatively small breaking elongation δ1 and the crystal particle diameter D1 and the active material layer non-existent section 1B having the relatively large breaking elongation δ2 and the crystal particle diameter D2. Thereafter, by dividing the current collector 1 and the like into pieces for every active material layer 2, a plurality of electrodes are completed.

In order to perform heat treatment for the purpose of differentiating the breaking elongations δ1 and δ2, performing heat treatment continuously with the use of the foregoing roll-to-roll method may be more preferable than performing heat treatment intermittently with the use of a so-called batch method. One reason for this is that, the breaking elongations δ1 and δ2 may be thereby differentiated easily and reproducibly. The same is applicable to the crystal particle diameters D1 and D2.

More specifically, in the batch method in which intermittent heat treatment is repeatedly performed for the current collector 1 and the like with the use of an oven, it is general to perform heat treatment for a long time for the purpose of stabilizing the electrode and the like. In this case, since time duration of the heat treatment is excessively long, the respective heating amounts supplied to the active material layer existent section 1A and the active material layer non-existent section 1B are easily larger beyond necessity. Thereby, both the active material layer existent section 1A and the active material layer non-existent section 1B are excessively heated. As a result, there is almost no difference between the breaking elongations δ1 and δ2. By some definition, it might be possible that, even if the batch method is adopted, as long as the active material layer existent section 1A and the active material layer non-existent section 1B are prevented from being excessively heated by shortening time duration of keeping the current collector 1 and the like in an oven or the like, the breaking elongations δ1 and δ2 are allowed to be differentiated. However, since heating time varies according to each heat treatment, it is difficult to reproducibly control the breaking elongations δ1 and δ2.

In contrast, in the roll-to-roll method in which continuous heat treatment is performed while the current collector 1 and the like are transferred with the use of the foregoing manufacturing equipment, time duration of the heat treatment for the current collector 1 and the like becomes appropriately shortened by adjusting the transfer velocity. Further, time duration of the heat treatment for every current collector 1 and the like becomes almost constant by keeping a constant value of the transfer velocity. In this case, the respective heating amounts supplied to the active material layer existent section 1A and the active material layer non-existent section 1B easily become appropriate, and time duration of the heat treatment is easily controlled. Therefore, the breaking elongations δ1 and δ2 are easily and stably controllable.

[Operation and Effect of Electrode]

According to the electrode, the breaking elongation δ2 of the active material layer non-existent section 1B is larger than the breaking elongation δ1 of the active material layer existent section 1A. In this case, as described above, the active material layer non-existent section 1B is easily deformed (expanded and shrunk) than the active material layer existent section 1A. Therefore, even if the active material layer 2 is expanded and shrunk at the time of electrode reaction, the active material layer non-existent section 1B easily follows stress generated at the time of expansion and shrinkage. Thereby, since a crack and/or the like is less likely to occur in the active material layer non-existent section 1B, breakage of the electrode at the time of an electrode reaction is allowed to be suppressed. Such an advantage is similarly obtainable by the fact that the crystal particle diameter D2 of the active material layer non-existent section 1B is larger than the crystal particle diameter D1 of the active material layer existent section 1A.

In particular, in the case where the anode active material contains an Si-based material, breakage of the electrode is suppressed even if the Si-based material that is easily expanded and shrunk at the time of an electrode reaction is used. Therefore, high energy density is obtainable while breakage of the electrode is suppressed.

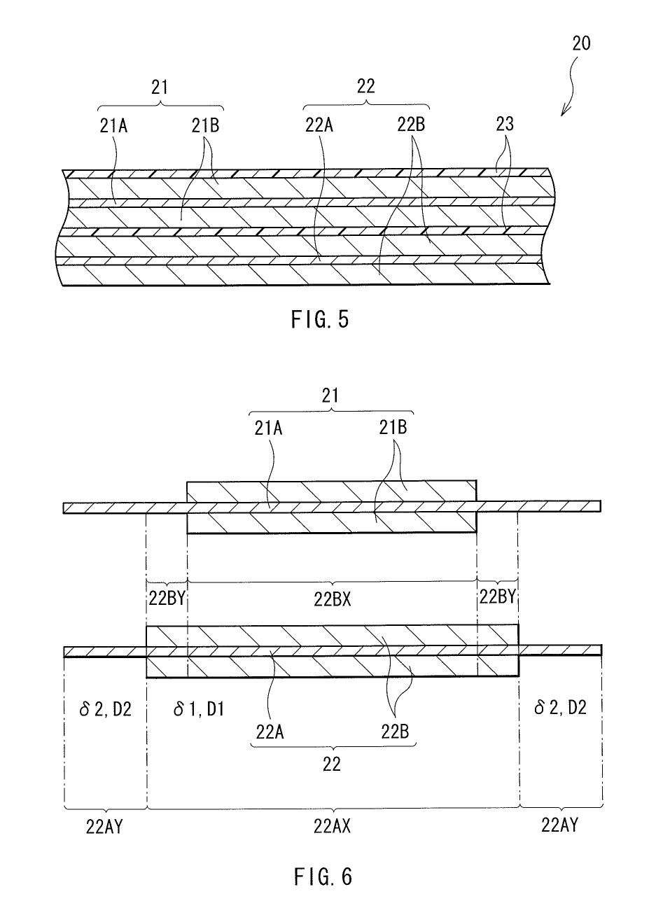

Further, as described later, in the case where the electrode is applied to an anode 22 of a secondary battery (see FIG. 6), a higher effect is obtainable. One reason for this is that, in the case where an active material layer non-existent section 22AY is formed in a wide range according to various purposes, breakage is allowed to be effectively suppressed in spite of tendency that the breakage rate of the active material layer non-existent section 22AY is increased.

In FIG. 1, the current collector 1 has the active material layer non-existent section 1B in one end and the other end thereof in the longitudinal direction and the active material layer existent section 1A in the central section. However, as long as the active material layer 2 is provided in part of the current collector 1, arrangement locations, the numbers of arrangement pieces, and the like of the active material layer existent section 1A and the active material layer non-existent section 1B are freely changeable. As an example, the current collector 1 may have the active material layer non-existent section 1B only in one end thereof, or may have the active material layer existent section 1A and the active material layer non-existent section 1B alternately and repeatedly. In these cases, a similar effect is obtainable as long as the breaking elongation δ2 is larger than the breaking elongation δ1.

Further, in order to obtain the breaking elongations δ1 and δ2 that are different from each other, the roll-to-roll heat treatment is adopted. Alternatively, other type of heat treatment may be used as long as at least the active material layer non-existent section 1B is allowed to be heated after the active material layer 2 is formed on the current collector 1. Specific examples of such other type of the heat treatment may include a selective heating-type heat treatment with the use of a heating source such as an infrared furnace. In such a heat treatment, only a specific section of the electrode is allowed to be selectively heated, and therefore, only the active material layer non-existent section 1B may be heated under desired conditions after the active material layer 2 is formed on the current collector 1. In this case, again, since the breaking elongation δ2 becomes larger than the breaking elongation δ1 by appropriately controlling the respective heating amounts supplied to the active material layer existent section 1A and the active material layer non-existent section 1B, a similar effect is obtainable.

It is to be noted that, in the case where the selective heating-type method is adopted, as described above, only the active material layer non-existent section 1B may be heated as long as the breaking elongation δ2 is allowed to be larger than the breaking elongation δ1 with the use of heat treatment. Alternatively, both the active material layer existent section 1A and the active material layer non-existent section 1B may be heated by differentiating heating conditions so that the heating amount supplied to the active material layer non-existent section 1B becomes larger than the heating amount supplied to the active material layer existent section 1A. In this case, for example, the heating amount supplied to the active material layer non-existent section 1B may become larger than the heating amount supplied to the active material layer existent section 1A by setting the heating temperature of the active material layer non-existent section 1B higher than the heating temperature of the active material layer existent section 1A.

[2. Secondary Battery and Method of Manufacturing the Same]

The foregoing electrode may be used for, for example, electrochemical devices as follows. A specific description will be given below of application examples of the electrode with the use of a secondary battery as an example of the electrochemical devices.

[2-1. Lithium Ion Secondary Battery (Cylindrical Type)]

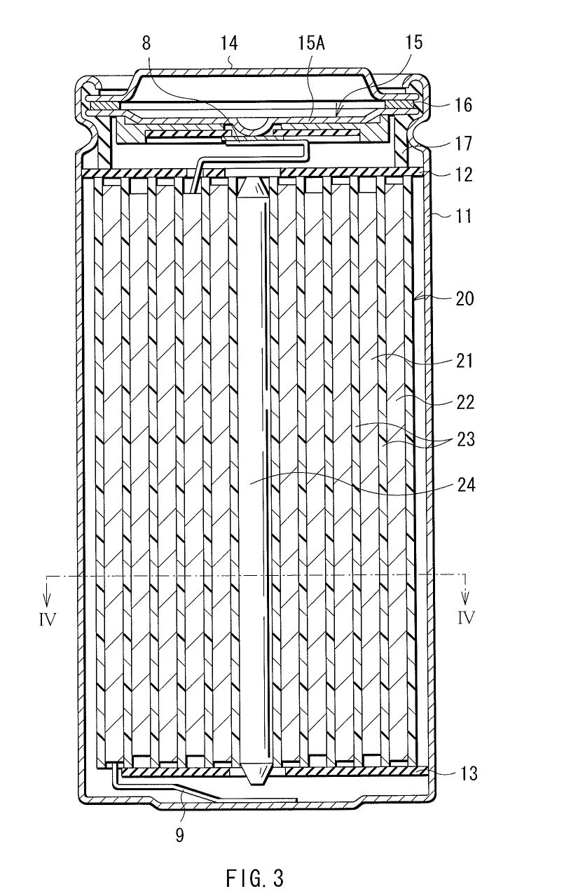

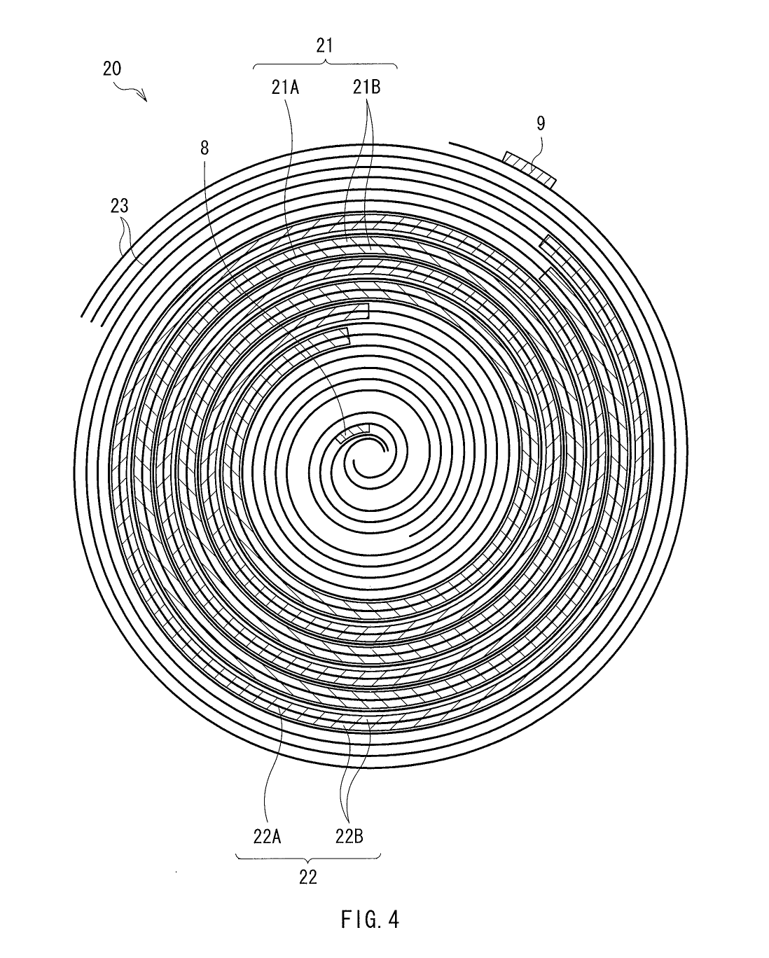

FIG. 3 illustrates a cross-sectional configuration of a secondary battery. FIG. 4 illustrates a cross-section taken along a line IV-IV of a spirally wound electrode body 20 illustrated in FIG. 3. FIG. 5 illustrates enlarged part of the spirally wound electrode body 20. FIG. 6 schematically illustrates plane configurations of a cathode 21 and an anode 22 illustrated in FIG. 4.

[Whole Configuration of Secondary Battery]

The secondary battery described here is a lithium secondary battery (lithium ion secondary battery) in which the capacity of the anode 22 is obtained by insertion and extraction of lithium (lithium ions) as an electrode reactant, and is a so-called cylindrical-type secondary battery.

In the secondary battery, for example, as illustrated in FIG. 3, a pair of insulating plates 12 and 13 and the spirally wound electrode body 20 are contained in a battery can 11 in the shape of a hollow cylinder. The spirally wound electrode body 20 may be formed by, for example, laminating the cathode 21 and the anode 22 with a separator 23 in between, and subsequently spirally winding the resultant laminated body. In this case, for example, the foregoing electrode may be applied to the anode 22.

The battery can 11 may have, for example, a hollow structure in which one end of the battery can 11 is closed and the other end of the battery can 11 is opened. The battery can 11 may be made of iron (Fe), aluminum (Al), an alloy thereof, or the like. The surface of the battery can 11 may be plated with nickel (Ni) or the like. The pair of insulating plates 12 and 13 is arranged to sandwich the spirally wound electrode body 20 in between, and to extend perpendicularly to the spirally wound periphery surface of the spirally wound electrode body 20.

At the open end of the battery can 11, a battery cover 14, a safety valve mechanism 15, and a positive temperature coefficient device (PTC device) 16 are attached by being swaged with a gasket 17. Thereby, the battery can 11 is hermetically sealed. The battery cover 14 may be made of, for example, a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating, or the like, a disk plate 15A inverts to cut electric connection between the battery cover 14 and the spirally wound electrode body 20. The PTC device 16 prevents abnormal heat generation resulting from a large current. As temperature rises, resistance of the PTC device 16 is increased accordingly. The gasket 17 may be made of, for example, an insulating material. The surface of the gasket 17 may be coated with asphalt.

In the center of the spirally wound electrode body 20, a center pin 24 is inserted as necessary. For example, a cathode lead 8 made of a conductive material such as aluminum may be connected to the cathode 21. For example, an anode lead 9 made of a conductive material such as nickel may be connected to the anode 22. For example, the cathode lead 8 may be welded to the safety valve mechanism 15, and may be electrically connected to the battery cover 14. For example, the anode lead 9 may be welded to the battery can 11, and may be electrically connected to the battery can 11 thereby.

[Cathode]

For example, as illustrated in FIG. 4 and FIG. 5, the cathode 21 may have a cathode active material layer 21B on a single surface or both surfaces of a cathode current collector 21A. The cathode current collector 21A may be made of, for example, a conductive material such as aluminum, nickel, and stainless steel.

The cathode active material layer 21B contains, as cathode active materials, one or more of cathode materials capable of inserting and extracting lithium ions. The cathode active material layer 21B may further contain other materials such as a cathode binder and a cathode electric conductor as necessary. Details of the cathode binder and the cathode electric conductor are similar to the binder and the electric conductor used for the foregoing electrode.

The cathode material may be preferably a lithium-containing compound, since high energy density is thereby obtained. Examples of the lithium-containing compound may include a lithium-transition-metal composite oxide and a lithium-transition-metal-phosphate compound. The lithium-transition-metal composite oxide is an oxide containing Li and one or more transition metal elements as constituent elements. The lithium-transition-metal-phosphate compound is a phosphate compound containing Li and one or more transition metal elements as constituent elements. In particular, it is preferable that the transition metal element be one or more of Co, Ni, Mn, Fe, and the like, since a higher voltage is obtained thereby. The chemical formula thereof may be expressed by, for example, LiₓM1O₂ or Li_{y}M2PO₄. In the formulas, M1 and M2 represent one or more transition metal elements. Values of x and y vary according to the charge and discharge state, and are generally in the range of 0.05≦x≦1.10 and 0.05≦y≦1.10.

Examples of the lithium-transition-metal composite oxide may include LiCoO₂, LiNiO₂, and a lithium-nickel-based composite oxide represented by the following Formula (I). Examples of the lithium-transition-metal-phosphate compound may include LiFePO₄ and LiFe₁₋ᵤMnᵤPO₄ (u<1), since thereby, a high battery capacity is obtained and superior cycle characteristics and the like are obtained.

LiNi_{1-z}M_{z}O₂ (1)

In Formula (I), M is one or more of Co, Mn, Fe, Al, V, Sn, Mg, Ti, Sr, Ca, Zr, Mo, Tc, Ru, Ta, W, Re, Yb, Cu, Zn, Ba, B, Cr, Si, Ga, P, Sb, and Nb. z satisfies 0.005<z<0.5.

In addition thereto, the cathode material may be, for example, an oxide, a disulfide, a chalcogenide, a conductive polymer, or the like. Examples of the oxide may include titanium oxide, vanadium oxide, and manganese dioxide. Examples of the disulfide may include titanium disulfide and molybdenum sulfide. Examples of the chalcogenide may include niobium selenide. Examples of the conductive polymer may include sulfur, polyaniline, and polythiophene. However, the cathode material is not limited to one of the foregoing materials, and may be other material.

[Anode]

The anode 22 has a configuration similar to that of the foregoing electrode. Specifically, for example, as illustrated in FIG. 4 and FIG. 5, the anode 22 may have an anode active material layer 22B on a single surface or both surfaces of an anode current collector 22A. Configurations of the anode current collector 22A and the anode active material layer 22B are respectively similar to the configurations of the current collector 1 and the active material layer 2.

In the secondary battery, in order to prevent lithium metal from being unintentionally precipitated on the anode 22 in the middle of charge, the electrochemical equivalent of the anode material capable of inserting and extracting lithium ions is preferably larger than the electrochemical equivalent of the cathode. Further, in the case where the open circuit voltage (that is, a battery voltage) at the time of completely-charged state is equal to or greater than 4.25 V, the extraction amount of lithium ions per unit mass is larger than that in the case where the open circuit voltage is 4.20 V even if the same cathode active material is used. Therefore, amounts of the cathode active material and the anode active material are adjusted accordingly. Thereby, high energy density is obtainable.

For example, as illustrated in FIG. 4 and FIG. 6, the cathode active material layer 21B may be provided on part of the surface of the cathode current collector 21A (such as the central region thereof in the longitudinal direction). Further, for example, the anode active material layer 22B may be provided on part of the anode current collector 22A (such as the central region thereof in the longitudinal direction) as the cathode active material layer 21B. Therefore, the anode current collector 22A includes an active material layer existent section 22AX (the breaking elongation δ1 and the crystal particle diameter D1) and the active material layer non-existent section 22AY (the breaking elongation δ2 and the crystal particle diameter D2).

It is to be noted that, for example, as illustrated in FIG. 4, the active material layer non-existent section 22AY located on the outer side of the spirally wound electrode body 20 may be spirally wound one or more times together with the cathode current collector 21A and the separator 23. The same is applicable to the active material layer non-existent section 22AY located on the inner side of the spirally wound electrode body 20. The active material layer non-existent section 22AY located on the inner side of the spirally wound electrode body 20 may be spirally wound one or more times together with the cathode current collector 21A and the separator 23.

However, in order to prevent lithium ions extracted from the cathode 21 at the time of charge from being unintentionally precipitated on the surface of the anode current collector 22A, the formation range of the anode active material layer 22B may be preferably more extended toward the inner side and the outer side of the spirally wound electrode body 20 than the formation range of the cathode active material layer 21B. Thereby, the anode active material layer 22B includes a section (opposed section 22BX) opposed to the cathode active material layer 21B and a section (non-opposed section 22BY) not opposed to the cathode active material layer 21B. In this case, out of the anode active material layer 22B, although the opposed section 22BX is related to charge and discharge, the non-opposed section 22BY is less likely to be related to charge and discharge.

As described above, the breaking elongation δ2 of the active material layer non-existent section 22AY is larger than the breaking elongation δ1 of the active material layer existent section 22AX. In this case, the anode current collector 22A may be, for example, deformed or denatured being influenced at the time of charge and discharge. Therefore, values of the breaking elongations δ1 and δ2 and the magnitude relation thereof may be changed from a state at the time of formation of the anode 22. However, in the non-opposed section 22BY, a state (physicality) of the anode current collector 22A is almost maintained being almost free of influence from charge and discharge. Therefore, for the physicality of the anode current collector 22A (the breaking elongations δ1 and δ2 and the crystal particle diameters D1 and D2), a section where the non-opposed section 22BY is formed in the anode current collector 22A may be preferably examined. One reason for this is that, in this case, the physicality of the anode current collector 22A is allowed to be examined more accurately and reproducibly without depending on history of charge and discharge (presence or absence of charge and discharge, the number of charge and discharge, and the like).

[Separator]

The separator 23 separates the cathode 21 from the anode 22, and passes lithium ions while preventing current short circuit resulting from contact of both electrodes. The separator 23 may be, for example, a porous film made of a synthetic resin, ceramics, or the like. The separator 23 may be a laminated film in which two or more types of porous films are laminated. Examples of the synthetic resin may include polytetrafluoroethylene, polypropylene, and polyethylene.

It is to be noted that, as described above, the separator 23 may be spirally wound one or more times on the outer side and the inner side of the spirally wound electrode body 20. However, a spirally winding state of the separator 23 on the outer side of the spirally wound electrode body 20 may be preferably determined according to an electrode terminal whose function is fulfilled by the battery can 11. Specifically, in the case where the battery can 11 functions as a terminal (anode terminal) that has homopolarity with respect to the electrode (anode 22) on the outer side of the spirally wound electrode body 20, if, for example, a nail or the like sticks in the secondary battery, it is necessary that the anode 22 and the battery can 11 are in contact with each other aggressively. Therefore, it is preferable that the number of spirally winding of the separator 23 be smaller than that of the active material layer non-existent section 22AY of the anode current collector 22A. In contrast, in the case where the battery can 11 functions as a terminal (cathode terminal) that has heteropolarity with respect to the electrode (anode 22) on the outer side of the spirally wound electrode body 20, it is necessary that the anode 22 and the battery can 11 are not in contact with each other aggressively. Therefore, it is preferable that the number of spirally winding of the separator 23 be larger than that of the active material layer non-existent section 22AY of the anode current collector 22A. In the latter case, it is preferable that the anode active material layer 22B be not provided at least in part (such as a section in the periphery of the end) of the outermost circumference of the anode current collector 22A. One reason for this is that, in this case, since the range where the active material layer non-existent section 22AY exists is decreased, a possibility that a crack or the like occurs in the active material layer non-existent section 22AY is lowered. However, the region where the anode active material layer 22B is not provided is not limited to part of the outermost circumference of the anode current collector 22A. That is, it is possible that the anode active material layer 22B is not provided in the entire outermost circumference of the anode current collector 22A, and the anode active material layer 22B is not also provided in part of the internal circumference in addition to the entire outermost circumference.

[Electrolytic Solution]

The separator 23 is impregnated with an electrolytic solution as a liquid electrolyte. The electrolytic solution contains a solvent and an electrolyte salt. However, the electrolytic solution may contain one or more of other materials such as an additive.

The solvent contains one or more of nonaqueous solvents such as an organic solvent. Examples of the nonaqueous solvents may include a cyclic ester carbonate, a chain ester carbonate, lactone, a chain carboxylic ester, and nitrile, since thereby, a superior battery capacity, superior cycle characteristics, superior conservation characteristics, and the like are obtained. Examples of the cyclic ester carbonate may include ethylene carbonate, propylene carbonate, and butylene carbonate. Examples of the chain ester carbonate may include dimethyl carbonate, diethyl carbonate, ethyl methyl carbonate, and methylpropyl carbonate. Examples of the lactone may include γ-butyrolactone and γ-valerolactone. Examples of the carboxylic ester may include methyl acetate, ethyl acetate, methyl propionate, ethyl propionate, methyl butyrate, methyl isobutyrate, methyl trimethylacetate, and ethyl trimethylacetate. Examples of the nitrile may include acetonitrile, glutaronitrile, adiponitrile, methoxyacetonitrile, and 3-methoxypropionitrile.

In addition thereto, examples of the nonaqueous solvent may include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. Thereby, a similar advantage is obtained.

In particular, one or more of ethylene carbonate, propylene carbonate, dimethyl carbonate, diethyl carbonate, and ethyl methyl carbonate may be preferable, since thereby, a superior battery capacity, superior cycle characteristics, superior conservation characteristics, and the like are obtained. In this case, a combination of a high viscosity (high dielectric constant) solvent (for example, specific dielectric constant ∈≧30) such as ethylene carbonate and propylene carbonate and a low viscosity solvent (for example, viscosity≦1 mPa·s) such as dimethyl carbonate, ethylmethyl carbonate, and diethyl carbonate may be more preferable. One reason for this is that the dissociation property of the electrolyte salt and ion mobility are improved.

In particular, the solvent may preferably contain one or more of unsaturated cyclic ester carbonate, a halogenated ester carbonate, sultone (cyclic sulfonic ester), and an acid anhydride, since the chemical stability of the electrolytic solution is thereby improved. The unsaturated cyclic ester carbonate is a cyclic ester carbonate having one or more unsaturated bonds (carbon-carbon double bonds). Examples of the unsaturated cyclic ester carbonate may include vinylene carbonate, vinylethylene carbonate, and methyleneethylene carbonate. The halogenated ester carbonate is a cyclic ester carbonate having one or more halogens as constituent elements or a chain ester carbonate having one or more halogens as constituent elements. Examples of a cyclic halogenated ester carbonate include 4-fluoro-1,3-dioxolane-2-one and 4,5-difluoro-1,3-dioxolane-2-one. Examples of a chain halogenated ester carbonate include fluoromethyl methyl carbonate, bis(fluoromethyl) carbonate, and difluoromethyl methyl carbonate. Examples of sultone may include propane sultone and propene sultone. Examples of the acid anhydrides may include a succinic anhydride, an ethane disulfonic anhydride, and a sulfobenzoic anhydride.

The electrolyte salt may contain, for example, one or more of salts such as a lithium salt. However, the electrolyte salt may contain, for example, a salt other than the lithium salt. Examples of “the salt other than the lithium salt” may include a light metal salt other than the lithium salt.

Examples of the lithium salts may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr). Thereby, a superior battery capacity, superior cycle characteristics, superior conservation characteristics, and the like are obtained. However, specific examples of the lithium salt are not limited to the foregoing compounds.

In particular, one or more of LiPF₆, LiBF₄, LiClO₄, and LiAsF₆ may be preferable, and LiPF₆ may be more preferable, since the internal resistance is thereby lowered, and therefore, a higher effect is obtained.

Although the content of the electrolyte salt is not particularly limited, in particular, the content thereof may be preferably from 0.3 mol/kg to 3.0 mol/kg both inclusive with respect to the solvent, since high ion conductivity is obtained thereby.

[Operation of Secondary Battery]

The secondary battery may operate, for example, as follows. At the time of charge, lithium ions extracted from the cathode 21 are inserted in the anode 22 through the electrolytic solution. In contrast, at the time of discharge, lithium ions extracted from the anode 22 are inserted in the cathode 21 through the electrolytic solution.

[Method of Manufacturing Secondary Battery]

The secondary battery may be manufactured, for example, by the following procedure.

First, the cathode 21 is fabricated. A cathode active material is mixed with a cathode binder and/or the like as necessary to prepare a cathode mixture. Subsequently, the cathode mixture is dispersed in an organic solvent or the like to obtain paste cathode mixture slurry. Subsequently, both surfaces of the cathode current collector 21A are coated with the cathode mixture slurry, which is dried to form the cathode active material layer 21B. Subsequently, the cathode active material layer 21B is compression-molded by using a roll pressing machine and/or the like as necessary. In this case, compression-molding may be performed while heating the cathode active material layer 21B, or compression-molding may be repeated several times.

Further, by a procedure similar to that of the electrode described above, after the anode active material layer 22B is formed on both surfaces of the anode current collector 22A, the breaking elongations δ1 and δ2 are differentiated by heat treatment, and thereby, the anode 22 is fabricated.

Finally, the secondary battery is assembled with the use of the cathode 21 and the anode 22. The cathode lead 8 is attached to the cathode current collector 21A with the use of a welding method and/or the like, and the anode lead 9 is attached to the anode current collector 22A with the use of a welding method and/or the like. Subsequently, the cathode 21 and the anode 22 are layered with the separator 23 in between and are spirally wound, and thereby, the spirally wound electrode body 20 is fabricated. Thereafter, the center pin 24 is inserted in the center of the spirally wound electrode body. Subsequently, the spirally wound electrode body 20 is sandwiched between the pair of insulating plates 12 and 13, and is contained in the battery can 11. In this case, the end tip of the cathode lead 8 is attached to the safety valve mechanism 15 with the use of a welding method and/or the like, and the end tip of the anode lead 9 is attached to the battery can 11 with the use of a welding method and/or the like. Subsequently, the electrolytic solution in which an electrolyte salt is dispersed in a solvent is injected into the battery can 11, and the separator 23 is impregnated with the electrolytic solution. Subsequently, at the open end of the battery can 11, the battery cover 14, the safety valve mechanism 15, and the PTC device 16 are fixed by being swaged with the gasket 17.

[Function and Effect of Secondary Battery]

According to the cylindrical-type secondary battery, the anode 22 has a configuration similar to that of the electrode described above. Therefore, a crack and/or the like is less likely to occur in the active material layer non-existent section 22AY of the anode current collector 22A. Therefore, breakage of the anode 22 at the time of charge and discharge is suppressed. Other operations and other effects are similar to those of the foregoing electrode and the like.

[2-2. Lithium Ion Secondary Battery (Laminated Film Type)]

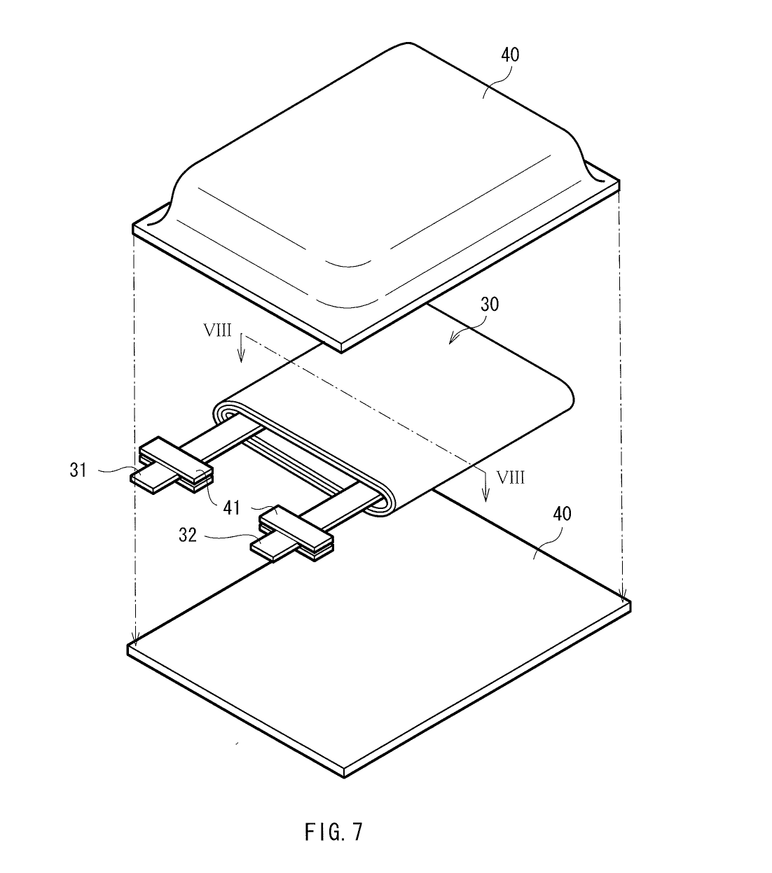

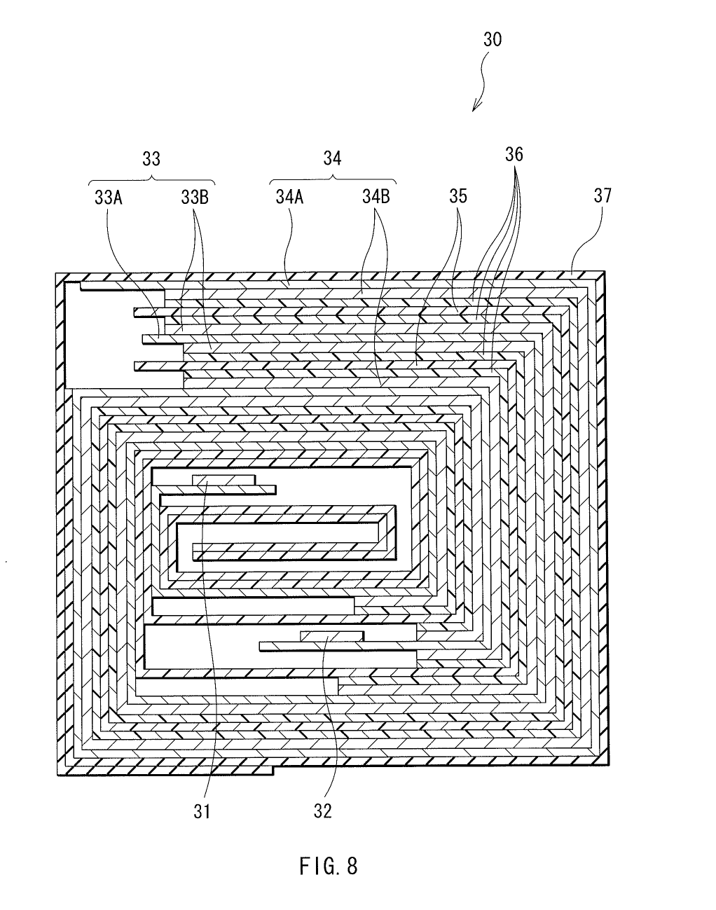

FIG. 7 illustrates an exploded perspective configuration of another secondary battery. FIG. 8 illustrates an enlarged cross-section taken along a line VIII-VIII of a spirally wound electrode body 30 illustrated in FIG. 7. However, FIG. 7 illustrates a state that the spirally wound electrode body 30 is separated from two pieces of outer package members 40. In the following description, the elements of the cylindrical-type secondary battery described above will be used as necessary.

[Whole Configuration of Secondary Battery]

The secondary battery described here may be, for example, a so-called laminated-film-type lithium ion secondary battery. For example, as illustrated in FIG. 7, the spirally wound electrode body 30 may be contained in a film-like outer package member 40. The spirally wound electrode body 30 is formed by laminating a cathode 33 and an anode 34 with a separator 35 and an electrolyte layer 36 in between, and subsequently spirally winding the resultant laminated body. A cathode lead 31 is attached to the cathode 33, and an anode lead 32 is attached to the anode 34. The outermost periphery of the spirally wound electrode body 30 is protected by a protective tape 37.

The cathode lead 31 and the anode lead 32 may be, for example, led out from inside to outside of the outer package member 40 in the same direction. The cathode lead 31 may be made of, for example, a conductive material such as aluminum, and the anode lead 32 may be made of, for example, a conducive material such as copper, nickel, and stainless steel. These conductive materials may be in the shape of, for example, a thin plate or mesh.

The outer package member 40 may be a laminated film in which, for example, a fusion bonding layer, a metal layer, and a surface protective layer are laminated in this order. The outer package member 40 may be formed by, for example, layering two laminated films so that the fusion bonding layers and the spirally wound electrode body 30 are opposed to each other, and subsequently fusion-bonding the respective outer edges of the fusion bonding layers to each other. Alternatively, the two laminated films may be attached to each other by an adhesive or the like. Examples of the fusion bonding layer may include a film made of polyethylene, polypropylene, or the like. Examples of the metal layer may include an aluminum foil. Examples of the surface protective layer may include a film made of nylon, polyethylene terephthalate, or the like.

In particular, as the outer package member 40, an aluminum laminated film in which a polyethylene film, an aluminum foil, and a nylon film are laminated in this order may be preferable. However, the outer package member 40 may be made of a laminated film having other laminated structure, a polymer film such as polypropylene, or a metal film.

An adhesive film 41 to protect from outside air intrusion is inserted between the outer package member 40 and the cathode lead 31 and between the outer package member 40 and the anode lead 32. The adhesive film 41 is made of a material having adhesion characteristics with respect to the cathode lead 31 and the anode lead 32. Examples of the material having adhesion characteristics may include a polyolefin resin. More specific examples thereof may include polyethylene, polypropylene, modified polyethylene, and modified polypropylene.

As illustrated in FIG. 8, the cathode 33 may have, for example, a cathode active material layer 33B on a single surface or both surfaces of a cathode current collector 33A. The anode 34 may have, for example, an anode active material layer 34B on a single surface or both surfaces of an anode current collector 34A. The configurations of the cathode current collector 33A, the cathode active material layer 33B, the anode current collector 34A, and the anode active material layer 34B are similar to the configurations of the cathode current collector 21A, the cathode active material layer 21B, the anode current collector 22A, and the anode active material layer 22B, respectively. Further, the configuration of the separator 35 is similar to the configuration of the separator 23.

In the electrolyte layer 36, an electrolytic solution is held by a polymer compound, and is a so-called gel electrolyte, since thereby, high ion conductivity (for example, 1 mS/cm or more at room temperature) is obtained and liquid leakage of the electrolytic solution is prevented. The electrolyte layer 36 may contain other material such as an additive as necessary.

Examples of the polymer compound may include one or more of polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethacrylic acid methyl, polyacrylic acid, polymethacrylic acid, styrene-butadiene rubber, nitrile-butadiene rubber, polystyrene, polycarbonate, and a copolymer of vinylidene fluoride and hexafluoro propylene. In particular, polyvinylidene fluoride or the copolymer of vinylidene fluoride and hexafluoro propylene is preferable, and polyvinylidene fluoride is more preferable, since such a polymer compound is electrochemically stable.

The composition of the electrolytic solution may be, for example, similar to the composition of the electrolytic solution of the cylindrical-type secondary battery. However, in the electrolyte layer 36 as a gel electrolyte, the term “solvent” of the electrolytic solution refers to a wide concept including not only a liquid solvent but also a material having ion conductivity capable of dissociating the electrolyte salt. Therefore, in the case where a polymer compound having ion conductivity is used, the polymer compound is also included in the solvent.

It is to be noted that the electrolytic solution may be used as it is instead of the gel electrolyte layer 36. In this case, the separator 35 is impregnated with the electrolytic solution.

[Operation of Secondary Battery]

The secondary battery operates, for example, as follows. At the time of charge, lithium ions extracted from the cathode 33 are inserted in the anode 34 through the electrolyte layer 36. In contrast, at the time of discharge, lithium ions extracted from the anode 34 are inserted in the cathode 33 through the electrolyte layer 36.

[Method of Manufacturing Secondary Battery]

The secondary battery including the gel electrolyte layer 36 may be manufactured, for example, by the following three types of procedures.

In the first procedure, the cathode 33 and the anode 34 are fabricated by a fabrication procedure similar to that of the cathode 21 and the anode 22. The cathode 33 is fabricated by forming the cathode active material layer 33B on both surfaces of the cathode current collector 33A. The anode 34 is fabricated by forming the anode active material layer 34B on both surfaces of the anode current collector 34A. Subsequently, a precursor solution including an electrolytic solution, a polymer compound, and a solvent such as an organic solvent is prepared. Thereafter, the cathode 33 and the anode 34 are coated with the precursor solution to form the gel electrolyte layer 36. Subsequently, the cathode lead 31 is attached to the cathode current collector 33A with the use of a welding method and/or the like, and the anode lead 32 is attached to the anode current collector 34A with the use of a welding method and/or the like. Subsequently, the cathode 33 and the anode 34 are layered with the separator 35 in between and are spirally wound to fabricate the spirally wound electrode body 30. Thereafter, the protective tape 37 is adhered to the outermost periphery thereof. Subsequently, after the spirally wound electrode body 30 is sandwiched between two pieces of film-like outer package members 40, the outer edges of the outer package members 40 are bonded with the use of a thermal fusion bonding method and/or the like. Thereby, the spirally wound electrode body 30 is enclosed into the outer package members 40. In this case, the adhesive films 41 are inserted between the cathode lead 31 and the outer package member 40 and between the anode lead 32 and the outer package member 40.

In the second procedure, the cathode lead 31 is attached to the cathode 33, and the anode lead 32 is attached to the anode 34. Subsequently, the cathode 33 and the anode 34 are layered with the separator 35 in between and are spirally wound to fabricate a spirally wound body as a precursor of the spirally wound electrode body 30. Thereafter, the protective tape 37 is adhered to the outermost periphery thereof. Subsequently, after the spirally wound body is sandwiched between two pieces of the film-like outer package members 40, the outermost peripheries except for one side are bonded with the use of a thermal fusion bonding method and/or the like to obtain a pouched state, and the spirally wound body is contained in the pouch-like outer package member 40. Subsequently, an electrolytic solution, a monomer as a raw material for the polymer compound, a polymerization initiator, and other materials such as a polymerization inhibitor as necessary are mixed to prepare a composition for electrolyte. Subsequently, the composition for electrolyte is injected into the pouch-like outer package member 40. Thereafter, the outer package member 40 is hermetically sealed with the use of a thermal fusion bonding method and/or the like. Subsequently, the monomer is thermally polymerized, and thereby, a polymer compound is formed. Accordingly, the polymer compound is impregnated with the electrolytic solution, the polymer compound gelates, and accordingly, the electrolyte layer 36 is formed.

In the third procedure, the spirally wound body is fabricated and contained in the pouch-like outer package member 40 in a manner similar to that of the foregoing second procedure, except that the separator 35 with both surfaces coated with a polymer compound is used. Examples of the polymer compound with which the separator 35 is coated may include a polymer (a homopolymer, a copolymer, or a multicomponent copolymer) containing vinylidene fluoride as a component. Specific examples of the homopolymer may include polyvinylidene fluoride. Specific examples of the copolymer may include a binary copolymer containing vinylidene fluoride and hexafluoro propylene as components. Examples of the multicomponent copolymer may include a ternary copolymer containing vinylidene fluoride, hexafluoro propylene, and chlorotrifluoroethylene as components. It is to be noted that, in addition to the polymer containing vinylidene fluoride as a component, other one or more polymer compounds may be used. Subsequently, an electrolytic solution is prepared and injected into the outer package member 40. Thereafter, the opening of the outer package member 40 is hermetically sealed with the use of a thermal fusion bonding method and/or the like. Subsequently, the resultant is heated while a weight is applied to the outer package member 40, and the separator 35 is adhered to the cathode 33 and the anode 34 with the polymer compound in between. Thereby, the polymer compound is impregnated with the electrolytic solution, and accordingly, the polymer compound gelates to form the electrolyte layer 36.

In the third procedure, swollenness of the secondary battery is suppressed more than in the first procedure. Further, in the third procedure, the monomer as a raw material of the polymer compound, the solvent, and the like are less likely to be left in the electrolyte layer 36 compared to in the second procedure. Therefore, the formation step of the polymer compound is favorably controlled. Therefore, the cathode 33, the anode 34, and the separator 35 sufficiently adhere to the electrolyte layer 36.

[Function and Effect of Secondary Battery]

According to the laminated-film-type secondary battery, the anode 34 has a configuration similar to that of the foregoing electrode. Therefore, for a reason similar to that of the cylindrical-type secondary battery, breakage of the anode 34 at the time of charge and discharge is allowed to be suppressed. Other functions and other effects are similar to those of the foregoing electrode and the like.

[2-3. Lithium Metal Secondary Battery (Cylindrical Type and Laminated Film Type)]

A secondary battery described here is a lithium secondary battery (lithium metal secondary battery) in which the capacity of the anode 22 is represented by precipitation and dissolution of lithium metal. The secondary battery has a configuration similar to that of the foregoing lithium ion secondary battery (cylindrical-type lithium ion secondary battery), except that the anode active material layer 22B is configured of the lithium metal, and is manufactured by a procedure similar to that of the lithium ion secondary battery (cylindrical-type lithium ion secondary battery).

In the secondary battery, the lithium metal is used as an anode active material, and thereby, higher energy density is obtainable. The anode active material layer 22B may exist at the time of assembling, or the anode active material layer 22B does not necessarily exist at the time of assembling and may be configured of the lithium metal precipitated at the time of charge. Further, the anode active material layer 22B may be used as a current collector, and thereby, the anode current collector 22A may be omitted.

The secondary battery operates, for example, as follows. At the time of charge, lithium ions are discharged from the cathode 21, and are precipitated as the lithium metal on the surface of the anode current collector 22A through the electrolytic solution. In contrast, at the time of discharge, the lithium metal is eluded as lithium ions from the anode active material layer 22B, and is inserted in the cathode 21 through the electrolytic solution.

According to the lithium metal secondary battery, for a reason similar to that of the foregoing lithium ion secondary battery, breakage of the anode 22 at the time of charge and discharge is allowed to be suppressed. Other functions and other effects are similar to those of the lithium ion secondary battery. It is to be noted that the lithium metal secondary battery is not limited to the cylindrical-type secondary battery, and may be a laminated-film-type secondary battery.

[3. Applications of Secondary Battery]

Next, a description will be given of application examples of the foregoing secondary battery.

Applications of the secondary battery are not particularly limited as long as the secondary battery is applied to a machine, a device, an instrument, an apparatus, a system (collective entity of a plurality of devices and the like), or the like that is allowed to use the secondary battery as a driving electric power source, an electric power storage source for electric power storage, or the like. It is to be noted that the secondary battery used as an electric power source may be a main electric power source (electric power source used preferentially), or may be an auxiliary electric power source (electric power source used instead of a main electric power source or used being switched from the main electric power source). In the case where the secondary battery is used as an auxiliary electric power source, the main electric power source type is not limited to the secondary battery.

Examples of applications of the secondary battery may include electronic apparatuses (including portable electronic apparatuses) such as a video camcorder, a digital still camera, a mobile phone, a notebook personal computer, a cordless phone, a headphone stereo, a portable radio, a portable television, and a personal digital assistant. Further examples thereof may include a mobile lifestyle electric appliance such as an electric shaver; a memory device such as a backup electric power source and a memory card; an electric power tool such as an electric drill and an electric saw; a battery pack used for a notebook personal computer or the like as an attachable and detachable electric power source; a medical electronic apparatus such as a pacemaker and a hearing aid; an electric vehicle such as an electric automobile (including a hybrid automobile); and an electric power storage system such as a home battery system for storing electric power for emergency or the like. It goes without saying that an application other than the foregoing applications may be adopted.

In particular, the secondary battery is effectively applicable to the battery pack, the electric vehicle, the electric power storage system, the electric power tool, the electronic apparatus, or the like. One reason for this is that, in these applications, since superior battery characteristics are demanded, performance is effectively improved with the use of the secondary battery according to the embodiment of the present application. It is to be noted that the battery pack is an electric power source using a secondary battery, and is a so-called assembled battery or the like. The electric vehicle is a vehicle that works (runs) with the use of a secondary battery as a driving electric power source. As described above, the electric vehicle may be an automobile (such as a hybrid automobile) including a drive source other than a secondary battery. The electric power storage system is a system using a secondary battery as an electric power storage source. For example, in a home electric power storage system, electric power is stored in the secondary battery as an electric power storage source, and the electric power is consumed as necessary. Thereby, home electric products and the like become usable. The electric power tool is a tool in which a movable section (such as a drill) is moved with the use of a secondary battery as a driving electric power source. The electronic apparatus is an apparatus executing various functions with the use of a secondary battery as a driving electric power source (electric power supply source).

A description will be specifically given of some application examples of the secondary battery. The configurations of the respective application examples explained below are merely examples, and may be changed as appropriate.

[3-1. Battery Pack]

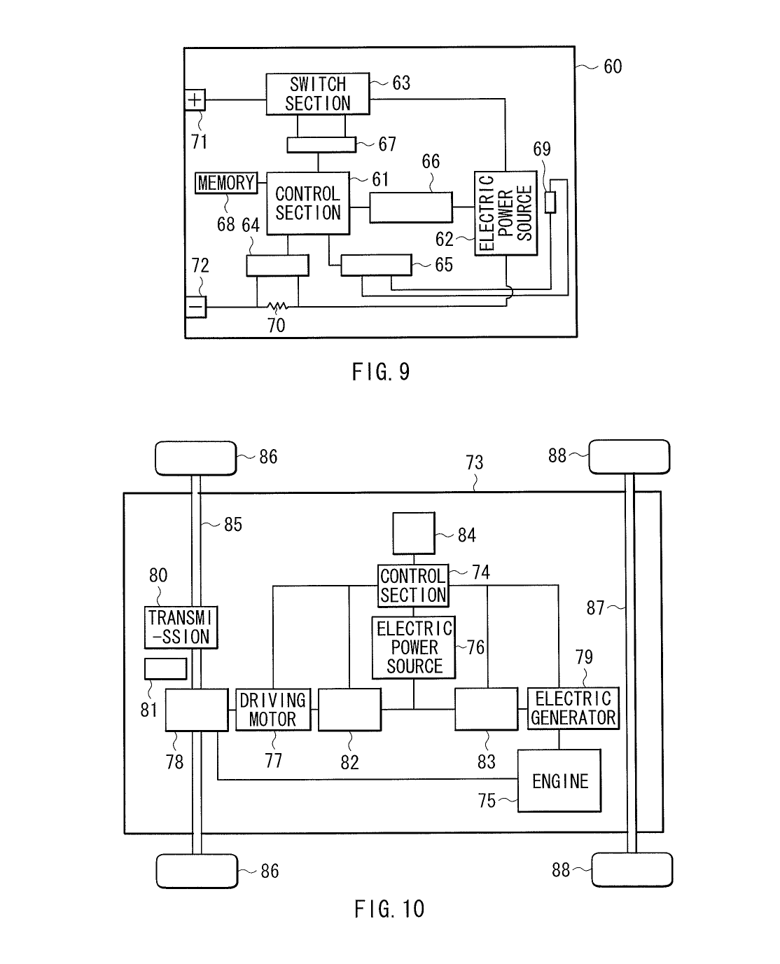

FIG. 9 illustrates a block configuration of a battery pack. For example, the battery pack may include a control section 61, an electric power source 62, a switch section 63, a current measurement section 64, a temperature detection section 65, a voltage detection section 66, a switch control section 67, a memory 68, a temperature detection device 69, a current detection resistance 70, a cathode terminal 71, and an anode terminal 72 in a housing 60 made of a plastic material and/or the like.

The control section 61 controls operation of the whole battery pack (including a used state of the electric power source 62), and may include, for example, a central processing unit (CPU) and/or the like. The electric power source 62 includes one or more secondary batteries (not illustrated). The electric power source 62 may be, for example, an assembled battery including two or more secondary batteries. Connection type of these secondary batteries may be a series-connected type, may be a parallel-connected type, or a mixed type thereof. As an example, the electric power source 62 may include six secondary batteries connected in a manner of dual-parallel and three-series.

The switch section 63 switches the used state of the electric power source 62 (whether or not the electric power source 62 is connectable to an external device) according to an instruction of the control section 61. The switch section 63 may include, for example, a charge control switch, a discharge control switch, a charging diode, a discharging diode, and the like (not illustrated). The charge control switch and the discharge control switch may each be, for example, a semiconductor switch such as a field-effect transistor (MOSFET) using a metal oxide semiconductor.

The current measurement section 64 measures a current with the use of the current detection resistance 70, and outputs the measurement result to the control section 61. The temperature detection section 65 measures temperature with the use of the temperature detection device 69, and outputs the measurement result to the control section 61. The temperature measurement result may be used for, for example, a case in which the control section 61 controls charge and discharge at the time of abnormal heat generation or a case in which the control section 61 performs a correction processing at the time of calculating a remaining capacity. The voltage detection section 66 measures a voltage of the secondary battery in the electric power source 62, performs analog-to-digital conversion on the measured voltage, and supplies the resultant to the control section 61.

The switch control section 67 controls operations of the switch section 63 according to signals inputted from the current measurement section 64 and the voltage measurement section 66.

The switch control section 67 executes control so that a charging current is prevented from flowing in a current path of the electric power source 62 by disconnecting the switch section 63 (charge control switch) in the case where, for example, a battery voltage reaches an overcharge detection voltage. Thereby, in the electric power source 62, only discharge is allowed to be performed through the discharging diode. It is to be noted that, for example, in the case where a large current flows at the time of charge, the switch control section 67 blocks the charging current.

Further, the switch control section 67 executes control so that a discharging current is prevented from flowing in the current path of the electric power source 62 by disconnecting the switch section 63 (discharge control switch) in the case where, for example, a battery voltage reaches an overdischarge detection voltage. Thereby, in the electric power source 62, only charge is allowed to be performed through the charging diode. It is to be noted that, for example, in the case where a large current flows at the time of discharge, the switch control section 67 blocks the discharging current.

It is to be noted that, in the secondary battery, for example, the overcharge detection voltage may be 4.20 V±0.05 V, and the over-discharge detection voltage may be 2.4 V±0.1 V.

The memory 68 may be, for example, an EEPROM as a nonvolatile memory or the like. The memory 68 may store, for example, numerical values calculated by the control section 61 and information of the secondary battery measured in a manufacturing step (such as an internal resistance in the initial state). It is to be noted that, in the case where the memory 68 stores a full charge capacity of the secondary battery, the control section 61 is allowed to comprehend information such as a remaining capacity.

The temperature detection device 69 measures temperature of the electric power source 62, and outputs the measurement result to the control section 61. The temperature detection device 69 may be, for example, a thermistor or the like.

The cathode terminal 71 and the anode terminal 72 are terminals connected to an external device (such as a notebook personal computer) driven using the battery pack or an external device (such as a battery charger) used for charging the battery pack. The electric power source 62 is charged and discharged through the cathode terminal 71 and the anode terminal 72.

[3-2. Electric Vehicle]

FIG. 10 illustrates a block configuration of a hybrid automobile as an example of electric vehicles. For example, the electric vehicle may include a control section 74, an engine 75, an electric power source 76, a driving motor 77, a differential 78, an electric generator 79, a transmission 80, a clutch 81, inverters 82 and 83, and various sensors 84 in a housing 73 made of metal. In addition thereto, the electric vehicle may include, for example, a front drive shaft 85 and a front tire 86 that are connected to the differential 78 and the transmission 80, a rear drive shaft 87, and a rear tire 88.

The electric vehicle is runnable by using one of the engine 75 and the motor 77 as a drive source. The engine 75 is a main power source, and may be, for example, a petrol engine. In the case where the engine 75 is used as a power source, drive power (torque) of the engine 75 may be transferred to the front tire 86 or the rear tire 88 through the differential 78, the transmission 80, and the clutch 81 as drive sections, for example. The torque of the engine 75 may also be transferred to the electric generator 79. Due to the torque, the electric generator 79 generates alternating-current electric power. The alternating-current electric power is converted into direct-current electric power through the inverter 83, and the converted power is stored in the electric power source 76. On the other hand, in the case where the motor 77 as a conversion section is used as a power source, electric power (direct-current electric power) supplied from the electric power source 76 is converted into alternating-current electric power through the inverter 82. The motor 77 may be driven by the alternating-current electric power. Drive power (torque) obtained by converting the electric power by the motor 77 is transferred to the front tire 86 or the rear tire 88 through the differential 78, the transmission 80, and the clutch 81 as the drive sections, for example.

It is to be noted that, alternatively, the following mechanism may be adopted. In the mechanism, when speed of the electric vehicle is reduced by an unillustrated brake mechanism, the resistance at the time of speed reduction is transferred to the motor 77 as torque, and the motor 77 generates alternating-current electric power by the torque. It is preferable that the alternating-current electric power be converted to direct-current electric power through the inverter 82, and the direct-current regenerative electric power be stored in the electric power source 76.

The control section 74 controls operations of the whole electric vehicle, and, for example, may include a CPU and/or the like. The electric power source 76 includes one or more secondary batteries (not illustrated). Alternatively, the electric power source 76 may be connected to an external electric power source, and electric power may be stored by receiving the electric power from the external electric power source. The various sensors 84 may be used, for example, for controlling the number of revolutions of the engine 75 or for controlling opening level (throttle opening level) of an unillustrated throttle valve. The various sensors 84 may include, for example, a speed sensor, an acceleration sensor, an engine frequency sensor, and/or the like.

The description has been given above of the hybrid automobile as an electric vehicle. However, examples of the electric vehicles may include a vehicle (electric automobile) working with the use of only the electric power source 76 and the motor 77 without using the engine 75.

[3-3. Electric Power Storage System]

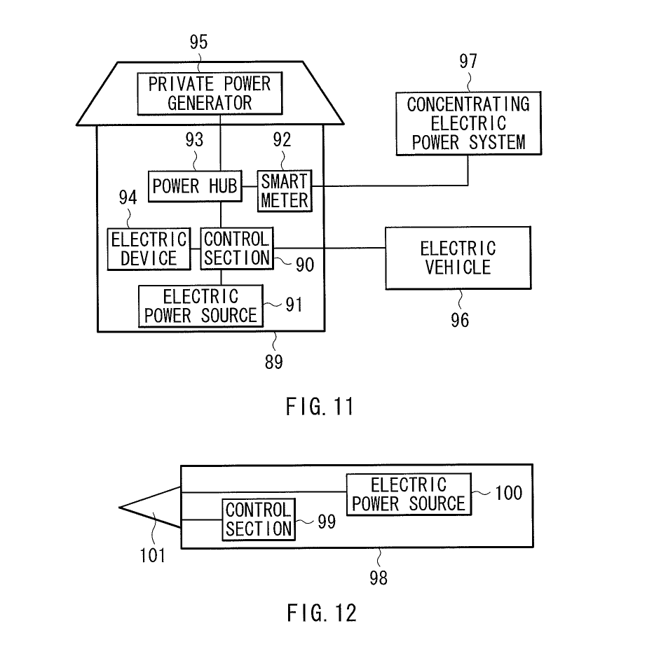

FIG. 11 illustrates a block configuration of an electric power storage system. For example, the electric power storage system may include a control section 90, an electric power source 91, a smart meter 92, and a power hub 93 inside a house 89 such as a general residence and a commercial building.

In this case, the electric power source 91 may be connected to, for example, an electric device 94 arranged inside the house 89, and may be connected to an electric vehicle 96 parked outside the house 89. Further, for example, the electric power source 91 may be connected to a private power generator 95 arranged inside the house 89 through the power hub 93, and may be connected to an external concentrating electric power system 97 thorough the smart meter 92 and the power hub 93.

It is to be noted that the electric device 94 may include, for example, one or more home electric appliances such as a refrigerator, an air conditioner, a television, and a water heater. The private power generator 95 may be, for example, one or more of a solar power generator, a wind-power generator, and the like. The electric vehicle 96 may be, for example, one or more of an electric automobile, an electric motorcycle, a hybrid automobile, and the like. The concentrating electric power system 97 may be, for example, one or more of a thermal power plant, an atomic power plant, a hydraulic power plant, a wind-power plant, and the like.

The control section 90 controls operation of the whole electric power storage system (including a used state of the electric power source 91), and, for example, may include a CPU and/or the like. The electric power source 91 includes one or more secondary batteries (not illustrated). The smart meter 92 may be, for example, an electric power meter compatible with a network arranged in the house 89 demanding electric power, and may be communicable with an electric power supplier. Accordingly, for example, while the smart meter 92 communicates with outside as necessary, the smart meter 92 controls the balance between supply and demand in the house 89 and allows effective and stable energy supply.

In the electric power storage system, for example, electric power may be stored in the electric power source 91 from the concentrating electric power system 97 as an external electric power source through the smart meter 92 and the power hub 93, and electric power may be stored in the electric power source 91 from the private power generator 95 as an independent electric power source through the power hub 93. As necessary, the electric power stored in the electric power source 91 is supplied to the electric device 94 or to the electric vehicle 96 according to an instruction of the control section 90. Therefore, the electric device 94 becomes operable, and the electric vehicle 96 becomes chargeable. That is, the electric power storage system is a system capable of storing and supplying electric power in the house 89 with the use of the electric power source 91.

The electric power stored in the electric power source 91 is arbitrarily usable. Therefore, for example, electric power is allowed to be stored in the electric power source 91 from the concentrating electric power system 97 in the middle of the night when an electric rate is inexpensive, and the electric power stored in the electric power source 91 is allowed to be used during daytime hours when an electric rate is expensive.

The foregoing electric power storage system may be arranged for each household (family unit), or may be arranged for a plurality of households (family units).

[3-4. Electric Power Tool]

FIG. 12 illustrates a block configuration of an electric power tool. For example, the electric power tool may be an electric drill, and may include a control section 99 and an electric power source 100 in a tool body 98 made of a plastic material and/or the like. For example, a drill section 101 as a movable section may be attached to the tool body 98 in an operable (rotatable) manner.

The control section 99 controls operations of the whole electric power tool (including a used state of the electric power source 100), and may include, for example, a CPU and/or the like. The electric power source 100 includes one or more secondary batteries (not illustrated). The control section 99 allows electric power to be supplied from the electric power source 100 to the drill section 101 as necessary according to operation of an unillustrated operation switch to operate the drill section 101.

### EXAMPLES

Specific Examples according to the embodiment of the present application will be described in detail.

### Examples 1 to 4

The cylindrical-type lithium ion secondary battery illustrated in FIG. 3 to FIG. 6 was fabricated by the following procedure.

Upon fabricating the cathode 21, first, 96 parts by mass of a cathode active material (LiNiO₂), 3 parts by mass of a cathode binder (polyvinylidene fluoride: PVDF), and 1 part by mass of a cathode electric conductor (graphite) were mixed to obtain a cathode mixture. Subsequently, the cathode mixture was dispersed in an organic solvent (N-methyl-2-pyrrolidone: NMP) to obtain paste cathode mixture slurry. Subsequently, both surfaces of the cathode current collector 21A in the shape of a strip (an aluminum foil being 20 μm thick) were coated with the cathode mixture slurry uniformly with the use of a coating device, which was dried to form the cathode active material layer 21B. In this case, the coating thickness of the cathode mixture slurry was adjusted so that the coating weight per unit area (total of both surfaces) became 80 mg/cm². Finally, the cathode active material layer 21B was compression-molded with the use of a roll pressing machine.

Upon fabricating the anode 22, first, 70 parts by mass of an anode active material (Si, median diameter: 5 μm), 20 parts by mass of an anode binder (polyamideimide), and 10 parts by mass of an anode electric conductor (graphite) were mixed to obtain an anode mixture. Subsequently, the anode mixture was dispersed in an organic solvent (NMP) to obtain paste anode mixture slurry. Subsequently, both surfaces of the anode current collector 22A in the shape of a strip (an electrolytic copper foil being 15 μm thick) were coated with the anode mixture slurry uniformly with the use of a coating device, which was dried to form the anode active material layer 22B. In this case, the coating thickness of the anode mixture slurry was adjusted so that the coating weight per unit area (total of both surfaces) became 10 mg/cm². Subsequently, the anode active material layer 22B was compression-molded with the use of a roll pressing machine. Finally, the anode current collector 22A and the like were heated under the following conditions.

In Example 1, with the use of the manufacturing equipment illustrated in FIG. 2, continuous heat treatment by a roll-to-roll method was performed in N₂ atmosphere. As heating conditions in this case, the heating temperature was 300 deg C., the transfer velocity was 2 m/minute, and the heating time was 1 minute. In Example 2, with the use of an infrared furnace, heat treatment by a selective heating method was performed. As heating conditions in this case, the heating temperature was 300 deg C. and the heating time was 10 seconds for the active material layer existent section 22AX; and the heating temperature was 500 deg C. and the heating time was 10 seconds for the active material layer non-existent section 22AY. In Example 3, with the use of an oven, intermittent heat treatment by a batch method was performed in vacuum atmosphere. As heating conditions in this case, the heating temperature was 300 deg C. and the heating time was 3 hours. In Example 4, heat treatment was performed by a procedure similar to that of Example 2, except that the active material layer non-existent section 22AY was not heated.

The breaking elongations δ1 and δ2(%) and the crystal particle diameters D1 and D2 (μm) after heat treatment are as illustrated in Table 1. It is to be noted that measurement methods, measurement conditions, and the like of the breaking elongations δ1 and δ2 and the crystal particle diameters D1 and D2 are as described above.

Upon preparing an electrolytic solution, an electrolyte salt (LiPF₆) was dissolved in a solvent (ethylene carbonate (EC) and diethyl carbonate (DEC)). In this case, the composition of the solvent was EC:DEC=50:50 at a weight ratio, and the content of the electrolyte salt with respect to the solvent was 1 mol/kg.

Upon assembling the secondary battery, first, the cathode lead 8 made of aluminum was ultrasonic-welded to the cathode current collector 21A of the cathode 21, and the anode lead 9 made of nickel was ultrasonic-welded to the anode current collector 22A of the anode 22. Subsequently, the cathode 21 and the anode 22 were layered with the separator 23 (microporous polypropylene film being 16 μm thick) in between and were spirally wound. Thereafter, the winding end section of the spirally wound body was fixed with the use of an adhesive tape to fabricate the spirally wound electrode body 20. Subsequently, the center pin 24 was inserted in the center of the spirally wound electrode body 20. Subsequently, while the spirally wound electrode body 20 was sandwiched between the pair of insulating plates 12 and 13, the spirally wound electrode body 20 was contained in the battery can 11 made of iron plated with nickel. In this case, one end of the cathode lead 8 was welded to the safety valve mechanism 15, and one end of the anode lead 9 was welded to the battery can 11. Subsequently, the electrolytic solution was injected into the battery can 11 by a vacuum impregnation method, and the separator 23 was impregnated with the electrolytic solution. Finally, at the open end of the battery can 11, the battery cover 14, the safety valve mechanism 15, and the PTC device 16 were fixed by being swaged with the gasket 17. The cylindrical-type secondary battery (outer diameter: 1.8 mm, height: 56 mm) was thereby completed.

Electrode state of the secondary battery was examined. Results illustrated in Table 1 were obtained.

Upon examining the electrode state, the secondary battery was disassembled after one cycle of charge and discharge, the anode 22 was taken out, and subsequently, the anode 22 was observed to check whether or not the active material layer non-existent section 22AY was broken. At the time of charge, charge was performed at a constant current of 400 mA until the upper limit voltage reached 4.2 V, and subsequently, charge was performed at a constant voltage of 4.2 V until the current reached 20 mA. At the time of discharge, discharge was performed at a constant current of 400 mA until the voltage reached the final voltage of 2.5 V. For evaluation of the electrode state, a case that no breakage occurred was rated as “good” and a case that breakage occurred was rated as “poor.”

TABLE 1

| | Active material layer | | Active material layer | | |
|---|---|---|---|---|---|
| | existent section | | non-existent section | | |
| | | Crystal | | Crystal | |
| | Breaking | particle | Breaking | particle | |
| | elongation | diameter | elongations | diameter | Electrode |
| Example | δ1 (%) | D1 (μm) | δ2 (%) | D2 (μm) | state |
| 1 | 9 | 1.5 | 10 | 5 | Good |
| 2 | 9 | 1.8 | 14 | 5 | Good |
| 3 | 9 | 5 | 9 | 5 | Poor |
| 4 | 9 | 1.8 | 5 | 1.3 | Poor |

Breakage state of the anode 22 was changed according to physicality of the anode current collector 22A (the active material layer existent section 22AX and the active material layer non-existent section 22AY).

More specifically, focusing attention on the tension strength of the anode current collector 22A, the breakage state of the anode 22 varied according to the magnitude relation of the breaking elongations δ1 and δ2. That is, in the case where the breaking elongations δ1 and δ2 were equal to each other, or the breaking elongation δ2 was smaller than the breaking elongation δ1, a crack occurred in the active material layer non-existent section 22AY. In contrast, in the case where the breaking elongation δ2 was larger than the breaking elongation δ1, a crack did not occur in the active material layer non-existent section 22AY.

Such a tendency was similarly obtained in the case where attention is focused on crystal characteristics of the anode current collector 22A. That is, in the case where the crystal particle diameter D2 was larger than the crystal particle diameter D1, a crack did not occur in the active material layer non-existent section 22AY. In contrast, in the cases other than the foregoing case, a crack occurred in the active material layer non-existent section 22AY.

The results show the following fact. That is, in the case where the breaking elongation δ2 is equal to or less than the breaking elongation δ1, the active material layer non-existent section 22AY is less likely to be deformed (expanded or shrunk), and therefore, the active material layer non-existent section 22AY is easily broken, being influenced by stress generated at the time of charge and discharge. In contrast, in the case where the breaking elongation δ2 is larger than the breaking elongation δ1, the active material layer non-existent section 22AY is easily deformed, and therefore, the active material layer non-existent section 22AY is less likely to be broken even if the active material layer non-existent section 22AY is influenced by stress generated at the time of charge and discharge. The same is applicable to the foregoing magnitude relation of the crystal particle diameters D1 and D2.

From the foregoing results, it was confirmed that in the case where the breaking elongation δ2 of the active material layer non-existent section was larger than the breaking elongation δ1 of the active material layer existent section, breakage of the anode was allowed to be suppressed.

The present application has been described with reference to the embodiment and Examples. However, the present application is not limited to the examples described in the embodiment and Examples, and various modifications may be made. For example, the secondary battery of the present application is similarly applicable to a secondary battery in which the anode capacity includes a capacity by inserting and extracting lithium ions and a capacity associated with precipitation and dissolution of lithium metal, and the battery capacity is expressed by the sum of these capacities. In this case, an anode material capable of inserting and extracting lithium ions is used, and the chargeable capacity of the anode material is set to a smaller value than the discharge capacity of the cathode.

Further, for example, the secondary battery of the present application is similarly applicable to a battery having other battery structure such as a square-type battery, a coin-type battery, and a button-type battery or a battery in which the battery device has other structure such as a laminated structure.

Further, the electrode reactant may be other Group 1 element such as Na and K, a Group 2 element such as Mg and Ca, or other light metal such as Al. The effect of the present application may be obtained without depending on the electrode reactant type, and therefore, even if the electrode reactant type is changed, a similar effect is obtainable.

It is possible to achieve at least the following configurations from the above-described example embodiments of the disclosure.

(1) A secondary battery including:

a cathode;

an anode; and

an electrolytic solution, wherein

the anode includes an anode active material layer, the anode active material layer being provided on part of an anode current collector, and

a breaking elongation δ2 (percent) of the anode current collector in a second region is larger than a breaking elongation δ1 (percent) of the anode current collector in a first region, the second region not being provided with the anode active material layer, and the first region being provided with the anode active material layer.

(2) The secondary battery according to (1), wherein a crystal particle diameter D2 (micrometers) of the anode current collector in the second region is larger than a crystal particle diameter D1 (micrometers) of the anode current collector in the first region.
(3) The secondary battery according (1) or (2), wherein

the anode current collector is spirally wound, and

the anode active material layer is not provided in at least part of an outermost circumference of the anode current collector.

(4) The secondary battery according to any one of (1) to (3), wherein the anode current collector includes copper (Cu) as a constituent element.
(5) The secondary battery according to any one of (1) to (4), wherein

the anode active material layer includes an anode active material, and

the anode active material includes one or more of silicon (Si), tin (Sn), and germanium (Ge) as constituent elements.

(6) The secondary battery according to any one of (1) to (5), wherein the breaking elongation δ2 is larger than the breaking elongation δ1 by 1 percent or more.
(7) The secondary battery according to any one of (2) to (6), wherein the crystal particle diameter D2 is larger than the crystal particle diameter D1 by 30 percent or more.
(8) The secondary battery according to any one of (1) to (7), wherein the anode current collector in which the breaking elongation δ2 is larger than the breaking elongation δ1 is obtained by forming the anode active material layer in the first region of an anode current collector in which the breaking elongations δ1 and δ2 are equal to each other, and subsequently heating the first region and the second region of the anode current collector in which the breaking elongations δ1 and δ2 are equal to each other.
(9) The secondary battery according to (8), wherein the first region and the second region of the anode current collector is heated by a roll-to-roll method.
(10) The secondary battery according to any one of (1) to (7), wherein the anode current collector in which the breaking elongation δ2 is larger than the breaking elongation δ1 is obtained by heating only the second region of an anode current collector in which the breaking elongations δ1 and δ2 are equal to each other.
(11) The secondary battery according to any one of (1) to (7), wherein the anode current collector in which the breaking elongation δ2 is larger than the breaking elongation δ1 is obtained by heating the first region and the second region of an anode current collector in which the breaking elongations δ1 and δ2 are equal to each other so that heating temperature of the second region is higher than heating temperature of the first region.
(12) The secondary battery according to any one of (1) to (11), wherein the secondary battery is a lithium secondary battery.
(13) A method of manufacturing a secondary battery including:

forming an anode active material layer on part of an anode current collector; and

forming an anode by heating the anode current collector in at least a second region out of the second region in which the anode active material layer is not formed and a first region in which the anode active material layer is formed.

(14) A battery pack including:

the secondary battery according to any one of (1) to (12);

a control section controlling a used state of the secondary battery; and

a switch section switching the used state of the secondary battery according to an instruction of the control section, wherein

a secondary battery includes a cathode, an anode, and an electrolytic solution,

the anode includes an anode active material layer, the anode active material layer being provided on part of an anode current collector, and

a breaking elongation δ2 (percent) of the anode current collector in a second region is larger than a breaking elongation δ1 (percent) of the anode current collector in a first region, the second region not being provided with the anode active material layer, and the first region being provided with the anode active material layer.

(15) An electric vehicle including:

the secondary battery according to any one of (1) to (12);

a conversion section converting electric power supplied from the secondary battery into drive power;

a drive section operating according to the drive power; and

a control section controlling a used state of the secondary battery, wherein

a secondary battery includes a cathode, an anode, and an electrolytic solution,

the anode includes an anode active material layer, the anode active material layer being provided on part of an anode current collector, and

a breaking elongation δ2 (percent) of the anode current collector in a second region is larger than a breaking elongation δ1 (percent) of the anode current collector in a first region, the second region not being provided with the anode active material layer, and the first region being provided with the anode active material layer.

(16) An electrode including an anode active material layer, the anode active material layer being provided on part of an anode current collector, wherein a breaking elongation δ2 (percent) of the anode current collector in a second region is larger than a breaking elongation δ1 (percent) of the anode current collector in a first region, the second region not being provided with the anode active material layer, and the first region being provided with the anode active material layer.
(17) An electric power storage system including:

the secondary battery according to any one of (1) to (12);

one or more electric devices supplied with electric power from the secondary battery; and

a control section controlling the supplying of the electric power from the secondary battery to the one or more electric devices.

(18) An electric power tool including:

the secondary battery according to any one of (1) to (12); and

a movable section being supplied with electric power from the secondary battery.

(19) An electronic apparatus including the secondary battery according to any one of (1) to (12) as an electric power supply source.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a cathode;
an anode; and
an electrolytic solution, wherein
the anode includes an anode active material layer, the anode active material layer being provided on part of an anode current collector, and
a breaking elongation δ2 (percent) of the anode current collector in a second region is larger than a breaking elongation δ1 (percent) of the anode current collector in a first region, the second region not being provided with the anode active material layer, and the first region being provided with the anode active material layer.

2. The secondary battery according to claim 1, wherein a crystal particle diameter D2 (micrometers) of the anode current collector in the second region is larger than a crystal particle diameter D1 (micrometers) of the anode current collector in the first region.

3. The secondary battery according to claim 1, wherein
the anode current collector is spirally wound, and
the anode active material layer is not provided in at least part of an outermost circumference of the anode current collector.

4. The secondary battery according to claim 1, wherein the anode current collector includes copper (Cu) as a constituent element.

5. The secondary battery according to claim 1, wherein
the anode active material layer includes an anode active material, and
the anode active material includes one or more of silicon (Si), tin (Sn), and germanium (Ge) as constituent elements.

6. The secondary battery according to claim 1, wherein the breaking elongation δ2 is larger than the breaking elongation δ1 by 1 percent or more.

7. The secondary battery according to claim 2, wherein the crystal particle diameter D2 is larger than the crystal particle diameter D1 by 30 percent or more.

8. The secondary battery according to claim 1, wherein the anode current collector in which the breaking elongation δ2 is larger than the breaking elongation δ1 is obtained by forming the anode active material layer in the first region of an anode current collector in which the breaking elongations δ1 and δ2 are equal to each other, and subsequently heating the first region and the second region of the anode current collector in which the breaking elongations δ1 and δ2 are equal to each other.

9. The secondary battery according to claim 8, wherein the first region and the second region of the anode current collector is heated by a roll-to-roll method.

10. The secondary battery according to claim 1, wherein the anode current collector in which the breaking elongation δ2 is larger than the breaking elongation δ1 is obtained by heating only the second region of an anode current collector in which the breaking elongations δ1 and δ2 are equal to each other.

11. The secondary battery according to claim 1, wherein the anode current collector in which the breaking elongation δ2 is larger than the breaking elongation δ1 is obtained by heating the first region and the second region of an anode current collector in which the breaking elongations δ1 and δ2 are equal to each other so that heating temperature of the second region is higher than heating temperature of the first region.

12. The secondary battery according to claim 1, wherein the secondary battery is a lithium secondary battery.

13. A method of manufacturing a secondary battery comprising:
forming an anode active material layer on part of an anode current collector; and
forming an anode by heating the anode current collector in at least a second region out of the second region in which the anode active material layer is not formed and a first region in which the anode active material layer is formed.

14. A battery pack comprising:
a secondary battery;
a control section controlling a used state of the secondary battery; and
a switch section switching the used state of the secondary battery according to an instruction of the control section, wherein
a secondary battery includes a cathode, an anode, and an electrolytic solution,
the anode includes an anode active material layer, the anode active material layer being provided on part of an anode current collector, and
a breaking elongation δ2 (percent) of the anode current collector in a second region is larger than a breaking elongation δ1 (percent) of the anode current collector in a first region, the second region not being provided with the anode active material layer, and the first region being provided with the anode active material layer.

15. An electric vehicle comprising:
a secondary battery;
a conversion section converting electric power supplied from the secondary battery into drive power;
a drive section operating according to the drive power; and
a control section controlling a used state of the secondary battery, wherein
a secondary battery includes a cathode, an anode, and an electrolytic solution,
the anode includes an anode active material layer, the anode active material layer being provided on part of an anode current collector, and
a breaking elongation δ2 (percent) of the anode current collector in a second region is larger than a breaking elongation δ1 (percent) of the anode current collector in a first region, the second region not being provided with the anode active material layer, and the first region being provided with the anode active material layer.
